(19) United States
(12) Patent Application Publication
(10) Pub. No.: US 2019/0208410 A1
(43) Pub. Date: Jul. 4, 2019

(54) SYSTEMS, DEVICES, AND METHODS FOR MANAGING COMMUNICATIONS OF ONE OR MORE COMPUTING DEVICES

(71) Applicant: Tink Labs Limited, Hong Kong (CN)

(72) Inventors: Philip Yuen, Hong Kong (CN); Chung Yin Terence Kwok, Hong Kong (CN); Chin Man Leon Chung, Hong Kong (CN); Zhangming Yuan, Hong Kong (CN)

(21) Appl. No.: 16/327,289

(22) PCT Filed: May 17, 2017
(86) PCT No.: PCT/CN2017/084781

§ 371 Date: Feb. 21, 2019

(51) Int. Cl. H04W 8/26; H04L 29/12; H04M 3/42

(52) U.S. Cl. CPC H04W 8/265; H04L 61/2046; H04W 88/16; H04M 3/42059; H04L 61/1547

(57) ABSTRACT

Embodiments relate to methods, systems, and devices for managing voice communications of computing devices. The method may include receiving a first user identification and first specified time period for enabling voice communications on a first computing device for the first user identification. The method may include associating a first unique identifier with the first computing device and first user identification. The method may include configuring the first computing device to receive incoming voice communications directed to the first unique identifier. The method may include receiving a second user identification and second specified time period for enabling voice communications on the first computing device for the second user identification. The method may include associating a second unique identifier with the first computing device and second user identification. The method may include configuring the first computing device to receive incoming voice communications directed to the second unique identifier.

### TECHNICAL FIELD

The present disclosure relates generally to managing and/or verifying communications of computing devices, and more specifically, the present disclosure relates generally to systems, devices, and methods for managing, including configuring, routing, directing, controlling, and/or verifying, of voice and data communications of and/or for one or more computing devices.

### BACKGROUND

Computing devices come in various shapes, sizes, configurations, and capabilities. In respect to mobile computing devices, mobile computing devices will typically include wireless communication capabilities so as to enable users to, among other things, carry on voice communications (e.g., telephone calls), access the Internet to search for information, interact with others via electronic mail (email) messages and/or social media networks, and conduct online shopping and other forms of e-commerce.

Mobile computing devices are typically capable of performing wireless communications in one or more of a plurality of ways. For example, mobile computing devices equipped with a subscriber identity module (or “SIM card”) and having an activated telephone number and telephone/voice service attached to the telephone number may be capable of voice communications (i.e., telephone calls). Mobile computing devices equipped with a SIM card and having an activated data service may also be capable of wireless data communications through 3G networks, 4G networks, 4G LTE networks, or the like. Today, a significant portion of the mobile computing devices available on the market are configurable to communicate through some, most, or all of these and other forms of wireless communications.

### BRIEF SUMMARY

The popularity and widespread use of mobile computing devices today stem largely from the convenience and portability of such devices, enabling users to perform wireless voice and data communications at virtually any time and location. Situations may arise, however, when there is a need to efficiently and effectively configure, manage, control, verify, approve, authorize, authenticate, and/or validate (hereinafter “manage”) voice and/or data communications of one or more computing devices so as to provide, among other things, convenience, improve privacy and safety, reduce costs, prevent fraud, and/or improve security of online transactions for each user of the computing devices. For example, there may be situations where there is a need or motivation to manage one or more computing devices, and such managing may include allowing several different users to use a computing device on a temporary, periodic, and/or intermittent basis.

As a more specific example, a hotel operator may want to provide one or more of its hotel guests with a voice communication-capable computing device (e.g., mobile smart phone) to use for the duration of the hotel guest's stay at the hotel. As typical hotel stays are in the order of a few days, each computing device will likely be used by hundreds or even thousands of different users during the lifetime of the computing device. Although a hotel guest may receive convenience and/or reduce roaming or long distance costs by allowing others (e.g., friends and contacts) to contact the hotel guest via a local telephone number of the computing device, it is likely that the hotel guest may receive telephone calls intended for one or more previous hotel guest that were given the same computing device (i.e., same telephone number). In order to prevent such unwanted calls intended for previous hotel guests and also protect the privacy of the hotel guest, the hotel operator would be required to purchase/acquire a new SIM card with a different telephone number each time a hotel guest checks out and/or a new hotel guest checks in and is provided with a computing device. Such a solution, however, is not only costly but also time-consuming for the hotel operator. Similar problems may also be encountered for other situations, such as situations where an employer provides an employee, contractor, customer, partner, etc. with temporary use of a computing device.

Situations may also arise when there is a need to verify and/or approve certain communications of and/or by one or more computing devices so as to, among other things, prevent fraud and/or attacks (e.g., by automated programs or engines, viruses, hackers, and/or thieves) and improve security and/or reliability of online bookings, reservations, and/or other transactions (e.g., purchasing a product and/or service, remitting other forms of payment, using online coupons, placing a deposit, etc.). For example, there may be situations where there is a need or motivation to verify (or further verify) online transaction requests performed by one or more computing devices, and such verifying of online transaction requests may include, among other things, performing a verification before approving and/or processing online purchases, reservations, bookings, redemptions, coupons, etc.

Accordingly, it is recognized in the present disclosure that there is a need for alternative, additional, and/or improved approaches to managing voice and/or data communications of computing devices that are temporarily, periodically, and/or intermittently provided, assigned, and/or loaned to different users, including the preventing of unwanted calls intended for previous users of the computing device and/or the protecting of the privacy of the current user. Furthermore, it is recognized in the present disclosure that there is a need for alternative, additional, and/or improved approaches to verifying and/or approving communications, including online transactions, of and/or by one or more computing devices.

Present example embodiments relate generally to and/or comprise systems, subsystems, processors, devices, logic, and methods for addressing conventional problems, including those described above and in the present disclosure, and more specifically, example embodiments relate to systems, subsystems, processors, devices, logic, and methods of managing, including configuring, routing, directing, controlling, verifying, and/or approving, (hereinafter “manage,” “managing,” or “management,” as applicable) of voice and data communications of one or more computing devices. Present example embodiments also relate generally to and/or comprise systems, subsystems, processors, devices, logic, and methods for addressing conventional problems, including those described above and in the present disclosure, and more specifically, example embodiments relate to systems, subsystems, processors, devices, logic, and methods of verifying, including checking, comparing, confirming, authenticating, authorizing, and/or validating, (hereinafter “verify,” “verifying,” or “verification,” as applicable) of communications, including transactions, of one or more computing devices.

In an exemplary embodiment, a system for managing voice communications is described. The system may include a communication gateway server. The communication gateway server may be configured to receive one or more user identifications, including a first user identification. For example, the communication gateway server may receive the user identifications, including the first user identification, from a database, another processor, a computing device, a network, the cloud, and/or an administrator. The communication gateway server may also be configured to generate, select, search for, retrieve, and/or obtain (hereinafter “generate,” “generating,” or “generation,” as applicable) a unique identifier for each of the one or more user identifications, including a first unique identifier for the first user identification. The first unique identifier may be generated based on the following: (i) the first unique identifier is not currently (or planned/scheduled to be) associated with any user identification, and/or (ii) the first unique identifier has not, during a specified time period, been previously associated with any user identification. The other unique identifiers may be generated in a similar manner. The communication gateway server may also be configured to associate, assign, link, and/or pair (hereinafter “associate,” “associating,” or “association,” as applicable) the first unique identifier with the first user identification (and/or create a relationship or pointer between the first unique identifier and the first user identification). The other unique identifiers may also be associated with the other user identifications in a similar manner. The communication gateway server may also be configured to receive one or more incoming voice calls, including a first incoming voice call. For example, the one or more incoming voice calls, including the first incoming voice call, may be one or more telephone calls to one or more main telephone numbers assigned to, configured for, and/or subscribed by the communication gateway server. The communication gateway server may also be configured to determine a caller identification of each received incoming voice call, including a caller identification of the first incoming voice call. For example, the caller identification may be a telephone number and/or name of the caller or computing device making the incoming voice call. The communication gateway server may also be configured to receive an input identifier for each received incoming voice call, including a first input identifier for the first incoming voice call. For example, the input identifier may be a series of numbers and/or characters entered by way of a keypad (e.g., virtual or physical telephone keypad) of the computing device making the incoming voice call. Alternatively or in addition, the input identifier may be a spoken word and/or image provided by the computing device making the incoming voice call. The communication gateway server may also be configured to establish a voice communication channel to connect the first incoming voice call to a first computing device associated with the first unique identifier. For example, the voice communication channel may be a Voice-over-IP (VoIP) channel connecting the incoming voice call from the computing device making the incoming voice call to the first computing device. The voice communication channel to the first computing device may be established by the communication gateway server when: (i) the first input identifier received for the first incoming voice call matches the first unique identifier (presently assigned to the first computing device), and (ii) one or more of the following apply: (a) the communication gateway server determines that the caller identification of the first incoming voice call has not previously called the first unique identifier at any time before the first unique identifier was associated with the first user identification, and/or (b) the communication gateway server determines that the caller identification of the first incoming voice call was involved with establishing a previous voice communication channel via a second unique identifier, and the second unique identifier was associated with the first user identification at the time such previous voice communication channel was established. The second unique identifier may be the same as or different from the first unique identifier. In an example embodiment, the second unique identifier may be different from the unique identifier.

In another exemplary embodiment, a method for managing voice communications is described. The method may include receiving one or more user identifications, including a first user identification. The method may further include generating a unique identifier for each of the one or more user identifications, including a first unique identifier for the first user identification. The first unique identifier may be generated based on the following: (i) the first unique identifier is not currently associated with any user identification, and/or (ii) the first unique identifier has not, during a specified time period, been previously associated with any user identification. The method may further include associating the first unique identifier with the first user identification. The method may further include receiving one or more incoming voice calls, including a first incoming voice call. The method may further include determining a caller identification of each received incoming voice call, including a caller identification of the first incoming voice call. The method may further include receiving an input identifier for each received incoming voice call, including a first input identifier for the first incoming voice call. The method may further include establishing a voice communication channel to connect the first incoming voice call to a first computing device associated with the first unique identifier when: (i) the first input identifier received for the first incoming voice call matches the first unique identifier, and (ii) one or more of the following apply: (a) a determination is made that the caller identification of the first incoming voice call has not previously called the first unique identifier before the first unique identifier was associated with the first user identification, and/or (b) a determination is made that the caller identification of the first incoming voice call was involved with establishing a previous voice communication channel via a second unique identifier, and the second unique identifier was associated with the first user identification at the time the previous voice communication channel was established. The second unique identifier may be the same as or different from the first unique identifier. In an example embodiment, the second unique identifier may be different from the unique identifier.

In another exemplary embodiment, a method for managing voice communications is described. The method may include receiving, at a communication gateway server, one or more user identifications, including a first user identification. The method may further include associating, by the communication gateway server, a unique identifier with each of the one or more user identification, including associating a first unique identifier with the first user identification. The method may further include receiving, by the communication gateway server, one or more incoming voice calls, including a first incoming voice call. The method may further include determining, by the communication gateway server, a caller identification of each received incoming voice call, including a caller identification of the first incoming voice call. The method may further include receiving, by the communication gateway server, an input identifier for each received incoming voice call, including a first input identifier for the first incoming voice call. The method may further include establishing, by the communication gateway server, a voice communication channel to connect the first incoming voice call to a first computing device associated with the first unique identifier. The establishing of the voice communication channel may be performed when a determination is made that the first input identifier received for the first incoming voice call matches the first unique identifier, and the caller identification of the first incoming voice call has not previously called the first unique identifier before the first unique identifier was associated with the first user identification.

In another exemplary embodiment, a method for managing voice communications is described. The method may include receiving, at a communication gateway server, a first user identification. The method may also include receiving, at the communication gateway server, a first specified time period for enabling voice communications on a first computing device for the first user identification. The method may further include associating, by the communication gateway server, a first unique identifier with the first user identification. The first unique identifier may also be associated with the first computing device. The method may further include configuring, by the communication gateway server, the first computing device to selectively or dynamically receive incoming voice communications directed to the first unique identifier. For example, a computing device that initiates an incoming telephone call to a main telephone number assigned to the communication gateway server may provide the first unique identifier to the communication gateway server (e.g., by way of entering keys of a telephone or full keypad, providing a spoken word, or providing an image), and upon receipt of the first unique identifier, the communication gateway server may direct the incoming telephone call to the first unique identifier (e.g., by establishing a voice communication channel such as a VoIP channel between the incoming voice call and the first computing device associated with the first unique identifier). The method may further include receiving, at the communication gateway server, a second user identification and a second specified time period for enabling voice communications on the first computing device for the second user identification. For example, a first user (having the first user identification) that was assigned the first computing device (which was associated with the first unique identifier) may no longer be assigned or allowed to use the first computing device, and a second user (having the second user identification) may now be assigned or allowed to use the same first computing device. The method may further include associating, by the communication gateway server, a second unique identifier with the first computing device and the second user identification. The method may further include configuring, by the communication gateway server, the first computing device to selectively receive incoming voice communications directed to the second unique identifier. In doing so, the first computing device, which was previously assigned to the first user and received voice communications directed to the first unique identifier, is now assigned to the second user and receives voice communications directed to the second unique identifier. The second unique identifier may be the same as or different from the first unique identifier. In an example embodiment, the second unique identifier may be different from the unique identifier so as to prevent unwanted calls intended for the first user from reaching the second user.

In another exemplary embodiment, a method for managing voice communications is described. The method may include configuring a communication gateway server to receive an instruction to create a first association for a first user identification. For example, the instruction may be sent by a processor, the communication gateway server itself, a computing device, a database, and/or an administrator. The method may further include configuring the communication gateway server to associate, as the first association, a first unique identifier with the first user identification. The method may further include configuring the communication gateway server to receive, after the first association, a first incoming voice call to the communication gateway server. The method may further include configuring the communication gateway server to determine a caller identification of the first incoming voice call. The method may further include configuring the communication gateway server to receive a first input identifier for the first incoming voice call. The method may further include configuring the communication gateway server to establish a voice communication channel connecting the first incoming voice call to a computing device associated with the first unique identifier. The method may further include configuring the communication gateway server to receive an instruction to remove the association for the first user identification. For example, a first user (having the first user identification) may no longer be assigned or allowed to use the computing device. The method may further include configuring the communication gateway server to un-associate the first unique identifier from the first user identification. The method may further include configuring the communication gateway server to receive an instruction to create a second association for the first user identification. For example, the first user (having the first user identification) may again be assigned or allowed to use a second computing device. The second computing device may be the same as or different from the computing device. The method may further include configuring the communication gateway server to associate, as the second association, a second unique identifier with the first user identification after the un-associating of the first unique identifier from the first user identification. The second unique identifier may be different from the first unique identifier. The method may further include configuring the communication gateway server to receive, after the second association, a second incoming voice call to the communication gateway server. The method may further include configuring the communication gateway server to determine a caller identification of the second incoming voice call. The method may further include configuring the communication gateway server to receive a second input identifier for the second incoming voice call. Responsive to a determination that the caller identification of the second incoming voice call matches the caller identification of the first incoming voice call and the second input identifier for the second incoming voice call matches the first unique identifier, the method may further include configuring the communication gateway server to prevent the second incoming voice call from automatically connecting to a computing device associated with the first unique identifier. For example, after the first user is assigned the second computing device (associated with the second unique identifier), another user (e.g., second user) may be assigned the computing device (that is associated with the first unique identifier). In this example embodiment, upon determination by the communication gateway server that the caller of the second incoming voice call had previously called the first user using the first unique identifier as the first input identifier, the communication gateway server will not allow the second incoming voice call to reach the second user assigned to the computing device (associated with the first unique identifier).

### BRIEF DESCRIPTION OF THE DRAWINGS

For a more complete understanding of the present disclosure, example embodiments, and their advantages, reference is now made to the following description taken in conjunction with the accompanying drawings, in which like reference numbers indicate like features, and:

FIG. 1 is an illustration of an example embodiment of a system for managing voice communications of one or more computing devices;

FIG. 2 is another illustration of an example embodiment of a system for managing voice communications of one or more computing devices;

FIG. 3 is an illustration of an example embodiment of a method of associating and configuring a computing device;

FIG. 4 is an illustration of an example embodiment of a method of establishing a voice communication channel between an associated/configured computing device and a telephone or another computing device;

FIG. 5 is an illustration of an example embodiment of a method of un-associating and un-configuring a computing device;

FIG. 6 is an illustration of an example embodiment of a method of verifying communications from a computing device; and

FIG. 7 is an illustration of an example embodiment of a verification process.

Although similar reference numbers may be used to refer to similar elements in the figures for convenience, it can be appreciated that each of the various example embodiments may be considered to be distinct variations.

Example embodiments will now be described with reference to the accompanying drawings, which form a part of the present disclosure and which illustrate example embodiments which may be practiced. As used in the present disclosure and the appended claims, the terms “embodiment,” “example embodiment,” “exemplary embodiment,” and “present embodiment” do not necessarily refer to a single embodiment, although they may, and various example embodiments may be readily combined and/or interchanged without departing from the scope or spirit of example embodiments. Furthermore, the terminology as used in the present disclosure and the appended claims is for the purpose of describing example embodiments only and is not intended to be limitations. In this respect, as used in the present disclosure and the appended claims, the term “in” may include “in” and “on,” and the terms “a,” “an,” and “the” may include singular and plural references. Furthermore, as used in the present disclosure and the appended claims, the term “by” may also mean “from,” depending on the context. Furthermore, as used in the present disclosure and the appended claims, the term “if” may also mean “when” or “upon,” depending on the context. Furthermore, as used in the present disclosure and the appended claims, the words “and/or” may refer to and encompass any and all possible combinations of one or more of the associated listed items.

### DETAILED DESCRIPTION

Mobile computing devices are typically capable of performing wireless communications in one or more of a plurality of ways. For example, mobile computing devices may be capable of voice communications (i.e., making/placing or receiving telephone calls) when the mobile computing device is equipped with a subscriber identity module (or “SIM card”) having an activated telephone number and telephone/voice service attached to the telephone number. Mobile computing devices may also be capable of wireless data communications through 3G networks, 4G networks, 4G LTE networks, or the like, when the mobile computing device is equipped with a SIM card having an activated data service. Today, a significant portion of the mobile computing devices available on the market are configurable to communicate through some, most, or all of these and other forms of wireless communications.

In view of the popularity and widespread use of mobile computing devices today, it is recognized that situations may arise when there is a need to efficiently and effectively configure, manage, direct, route, bridge, connect, forward, control, and/or verify (hereinafter “manage”) voice and/or data communications of one or more computing devices so as to, among other things, provide convenience, improve privacy and safety, reduce costs, prevent fraud, and/or improve security and reliability for each user of the computing devices. For example, there may be situations where there is a need or motivation to allow a computing device to be used by several different users on a temporary, periodic, and/or intermittent basis.

As a non-limiting example, a hotel operator may want to provide one or more of its hotel guests with a voice communication-capable computing device (e.g., mobile smart phone) to use for the duration of the hotel guest's stay at the hotel. As typical hotel stays are in the order of a few days, each computing device will likely be used by hundreds or even thousands of different users during the lifetime of the computing device. Although a hotel guest may receive convenience and/or reduce roaming or long distance costs by allowing others (e.g., friends and contacts) to contact the hotel guest via a local telephone number of the computing device, it is likely that the hotel guest may receive telephone calls intended for one or more previous hotel guest that were given the same computing device (i.e., same telephone number). In order to prevent such unwanted calls intended for previous hotel guests while also protecting the privacy of the hotel guest, the hotel operator would be required to purchase/acquire a new SIM card with a different telephone number each time a hotel guest checks out and/or a new hotel guest checks in and is provided with a computing device. Such a solution, however, is not only costly but also time-consuming for the hotel operator.

As another non-limiting example, a tour operator may want to provide added convenience to its tour guests by providing some or all of its tour guests with a computing device to use for the duration of the tour. Such tour guests may also receive unwanted telephone calls intended for previous tour guests that were given the same computing device and/or telephone number.

In yet another non-limiting example, an employer may want to provide one or more of its employees, contractors, consultants, customers, partners, etc. with a computing device on a temporary basis. Such persons may also receive unwanted telephone calls intended for previous users of the same computing device and/or telephone number.

As another non-limiting example, in a situation where a person or company conducts services pertaining to renting or loaning out computing devices on a temporary basis to customers, the customers may also receive unwanted telephone calls intended for previous customers that were given the same computing device and/or telephone number.

In yet another non-limiting example, a hotel operator, tour operator, employer, person, and/or company in one or more of the examples described above and in the present disclosure may have a need or want to verify and/or approve certain communications of and/or by one or more computing devices so as to, among other things, prevent fraud and/or attacks (e.g., by automated programs or engines, viruses, hackers, and/or thieves) and improve security and/or reliability of communications. Communications may include communication requests in the form of online bookings, reservations, and/or other transactions (e.g., purchasing a product and/or service, remitting other forms of payment, using online coupons, placing a deposit, etc.). For example, there may be situations where there is a need or motivation to verify (or further verify) online transactions performed by one or more computing devices, and such online transactions may include, among other things, online purchases, reservations, bookings, redemptions, coupons, etc.

In view of the non-limiting example situations described above and in the present disclosure, as well as other situations not described but contemplated in the present disclosure, it is recognized that a need exists for alternative, additional, and/or improved approaches to managing voice and/or data communications of computing devices that are regularly, periodically, temporarily, and/or intermittently provided, assigned, rented, and/or loaned to different users, including the preventing of unwanted calls intended for previous users of the computing device and/or the protecting of the privacy of the current user. Furthermore, it is recognized in the present disclosure that there is a need for alternative, additional, and/or improved approaches to verifying and/or approving communications, including online transactions, of and/or by one or more computing devices.

Present example embodiments relate generally to and/or comprise systems, subsystems, processors, devices, logic, and methods for addressing conventional problems, including those described above and in the present disclosure, and more specifically, example embodiments relate to systems, subsystems, processors, devices, logic, and methods of managing of voice and/or data communications of one or more computing devices. Present example embodiments also relate generally to and/or comprise systems, subsystems, processors, devices, logic, and methods for verifying communications, including transactions, of one or more computing devices. Although example embodiments may be described in the present disclosure as pertaining to and/or for use with voice communications and/or hospitality-based situations, it is to be understood that example embodiments may also be applicable to and/or for use in other environments, surroundings, situations, circumstances, and/or applications, including, but not limited to, data communications, social media, etc., without departing from the teachings of the present disclosure. These example embodiments will now be described below with reference to the accompanying figures, which form a part of the present disclosure.

Example Embodiments of a System for Managing Voice Communications of One or More Computing Devices (e.g., System 100).

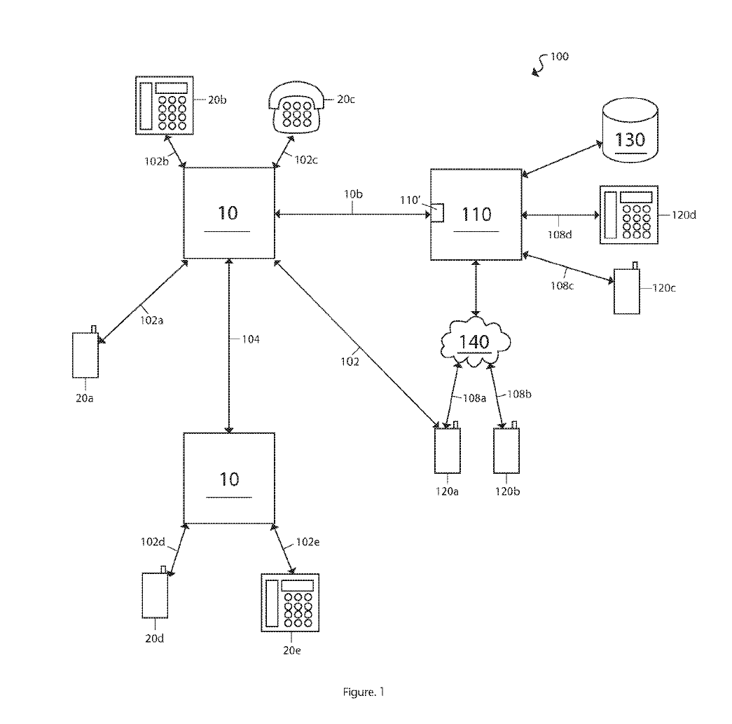

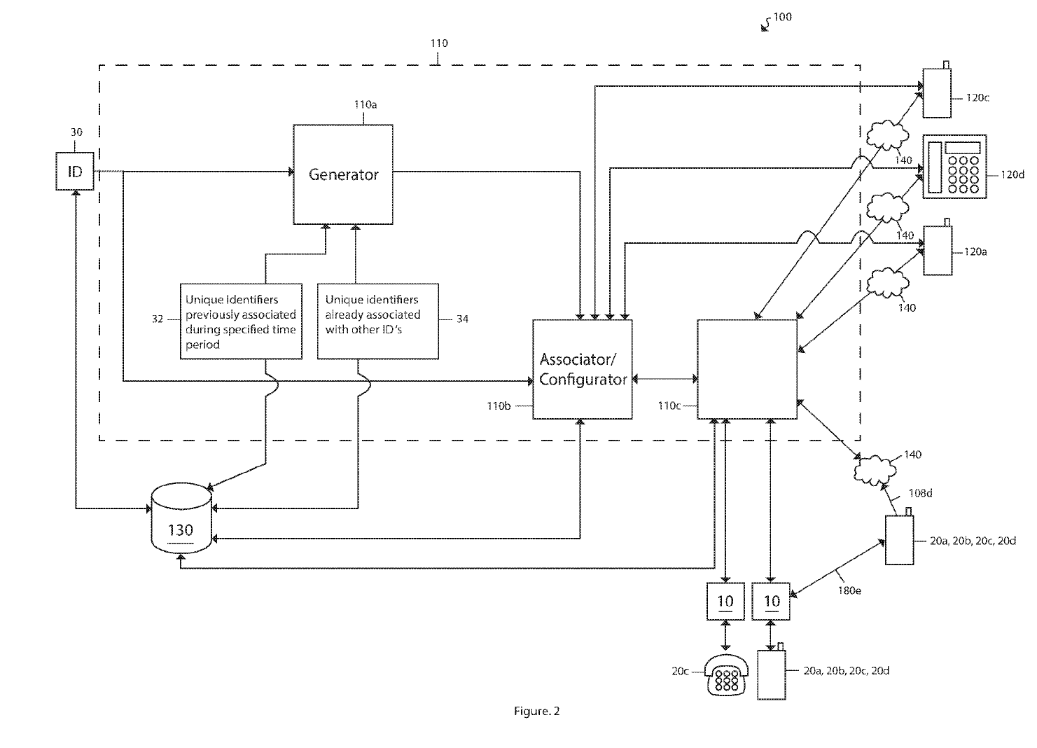

As an overview, an example embodiment of a system (e.g., system 100) for use in managing voice communications of one or more computing devices is illustrated in FIG. 1 and FIG. 2. The system (e.g., system 100) may comprise and/or be configurable or configured to communicate with one or more communication gateway servers (e.g., processor 110) and/or verification servers (e.g., processor 110). As used in the present disclosure, when applicable, a reference to a “communication gateway server (e.g., processor 110),” “communication gateway server,” “verification server (e.g., processor 110),” “verification server,” or “processor” may also refer to, apply to, and/or include a “communication gateway server 110,” “communication server,” “verification server 110,” “verification server,” “gateway server,” “server,” “processor 110,” “processor,” “computing device,” or the like, described in the present disclosure and/or illustrated in the accompanying figures, and vice versa.

In an example embodiment, the system (e.g., system 100) may also include and/or be configurable to communicate with one or more computing devices (e.g., computing devices 120a, 120b, 120c, and/or 120d illustrated in FIG. 1; computing devices 120a, 120c, and/or 120d illustrated in FIG. 2). As used in the present disclosure, when applicable, a reference to a “computing device 120,” “computing device,” “mobile smart phone,” “mobile phone,” and/or one or more of the computing devices 120a, 120b, 120c, and 120d may also refer to, apply to, and/or include one or more of the computing devices 120, 120a, 120b, 120c, and/or 120d described in the present disclosure and/or illustrated in the accompanying figures, and vice versa, without departing from the teachings of the present disclosure.

The system (e.g., system 100) may also include and/or be configurable to communicate with one or more databases (e.g., database 130 illustrated in FIGS. 1 and 2), one or more networks (e.g., network 140 illustrated in FIGS. 1 and 2), and/or the cloud.

The system (e.g., system 100) may also be configurable to communicate with one or more telephone networks, telephone systems, telephone devices, and/or telephone operators (hereinafter collectively “telephone network”). Each telephone network (e.g., telephone network 10) may be operable to provide or assist in providing one or more of a plurality of telephony-related services including, but not limited to, managing, receiving, connecting, routing, directing, re-directing, forwarding, bridging, etc. of voice communications (e.g., telephone calls) to and/or from telephones (e.g., device 20c illustrated in FIG. 1), Voice-over-IP (“VoIP”) phones (e.g., devices 20a, 20b, 20d, 20e, 120a, 120b, 120c, and 120d illustrated in FIG. 1; device 120a, 120c, and 120d illustrated in FIG. 2), computing devices (e.g., devices 20a, 20b, 20d, 20e, 120a, 120b, 120c, and 120d illustrated in FIG. 1; devices 120a, 120c, and 120d illustrated in FIG. 2), communication gateway servers (e.g., processor 110), and/or other telephone networks (e.g., telephone network 10). Example telephone networks (e.g., telephone network 10) include, but are not limited to, those provided by AT&T, Bell, T-Mobile, China Mobile, Vodafone, PCCW, Telstra, etc.

Example embodiments of the system (e.g., system 100) may include or not include one or more of the elements described above and in the present disclosure, may include additional elements, may be formed and/or used in different sequences, actions, combinations, and/or configurations, and/or one or more of the elements (and/or elements of elements) may be combinable into a single element or divided into two or more elements. Communications using technologies other than telephone networks and mobile or cellular networks are also contemplated in example embodiments without departing from the teachings of the present disclosure. These systems (e.g., system 100), and elements thereof, will now be further explained with reference to the accompanying figures.

Computing Device (e.g., Computing Device 120).

As illustrated in at least FIGS. 1 and 2, the system (e.g., system 100) may include one or more computing devices (e.g., computing device 120). Each computing device (e.g., computing device 120) may be any device, computing device, mobile computing device, VoIP phone, processor, controller, or the like, configurable or configured to perform, among other things, a processing of information, voice and/or data communications, capturing of information (e.g., image capturing via an image capturing portion of the computing device, such as a camera; voice capturing via a voice capturing portion of the computing device, such as a microphone; location capturing via a location capturing portion of the computing device, such as a GPS; biometric capturing via a biometric capturing portion of the computing device, such as a fingerprint scanner), and/or any of the other actions described above and in the present disclosure.

An example embodiment of the computing device (e.g., computing device 120) may be configurable or configured to be in voice and/or data communications with one or more elements of the system (e.g., system 100). For example, the computing device (e.g., computing device 120) may be configurable or configured to perform voice and data communications through one or more networks (e.g., network 140) and/or telephone networks (e.g., telephone network 10), such as via a voice and/or data-activated SIM card installed in the computing device (e.g., computing device 120), or the like. In addition to or in replacement, the computing device (e.g., computing device 120) may be configurable or configured to perform voice and/or data communications via data networks and/or local area networks, such as wireless local area networks (WLANs) and/or via other forms, such as Bluetooth, NFC, and other forms of short or long range wireless signals. One or more of the aforementioned communications may be between example embodiments of the computing device (e.g., computing device 120) and one or more communication gateway servers (e.g., processor 110), one or more verification servers (e.g., processor 110), one or more telephones (e.g., device 20c), one or more other computing devices (e.g., computing device 20), one or more telephone networks (e.g., telephone network 10), one or more networks (e.g., network 140), one or more trusted third party networks or systems (e.g., network 140) such as a bank network or system, clearing house, credit card or debit card processing system or network, etc., and/or the cloud.

In an example embodiment, the computing device (e.g., computing device 120) may be any computing device, such as an iPhone or Android device, issued by an employer to an employee for temporary use. The computing device (e.g., computing device 120) may also be any computing device, such as an iPad or Android tablet, issued by a university (or other educational institution) to a student for temporary use. The computing device (e.g., computing device 120) may also be any computing device, such as an iPhone or Android device, provided by a hotel operator to a hotel guest for the hotel guest to use during their stay at the hotel. The computing device (e.g., computing device 120) may also be any computing device, such as an iPhone or Android device, rented out to a customer to use for a temporary time period. Other example situations, applications, and uses are contemplated without departing from the teachings of the present disclosure. Example embodiments, including those illustrated in FIGS. 1-5, may be applicable for use in one or more of the example situations, applications, and uses described above and in the present disclosure, as well as for other situations.

The computing device (e.g., computing device 120) may have installed an operating system, such as a version of the Android operating system, a version of the iOS operating system, etc., configurable or configured to enable a processor of the computing device (e.g., computing device 120) to perform, either in part or in whole, directly or indirectly, one or more of the actions described above and in the present disclosure. The computing device (e.g., computing device 120) may also include one or more software applications installed (e.g., mobile applications, VoIP or other telephony applications, widgets, etc.) which, when executed by a processor of the computing device (e.g., computing device 120), enable the computing device (e.g., computing device 120) to perform, either in part or in whole, directly or indirectly, one or more of the actions described above and in the present disclosure. The computing device (e.g., computing device 120) may also be configurable or configured to perform, either in part or in whole, directly or indirectly, one or more of the actions described above and in the present disclosure via cloud computing, or the like.

Communication Gateway Server (e.g., Processor 110).

As illustrated in at least FIGS. 1 and 2, the system (e.g., system 100) may include one or more communication gateway servers (e.g., processor 110). The communication gateway server (e.g., processor 110) may be any processor, device, computing device, server, communication server, gateway server, communication gateway server, controller, microprocessor, microcontroller, microchip, semiconductor device, or the like, configurable or configured to perform, among other things, a processing of information, voice and/or data communications, and/or other actions described above and in the present disclosure. The communication gateway server (e.g., processor 110) may also include and/or be a part of a virtual machine, processor, computer, node, instance, host, or machine, including those in a networked computing environment. As used in the present disclosure, such a network and/or cloud (e.g., network 140′) may be a collection of devices connected by communication channels that facilitate communications between devices and allow for devices to share resources. Such resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof. A network or cloud may include, but is not limited to, computing grid systems, peer to peer systems, mesh-type systems, distributed computing environments, cloud computing environment, etc. Such network or cloud may include hardware and software infrastructures configured to form a virtual organization comprised of multiple resources which may be in geographically disperse locations. Network may also refer to a communication medium between processes on the same device. Also as referred to herein, a network element, node, or server may be a device deployed to execute a program operating as a socket listener and may include software instances.

An example embodiment of the communication gateway server (e.g., processor 110) may be configurable or configured to be in voice and/or data communications with one or more elements of the system (e.g., system 100). For example, the communication gateway server (e.g., processor 110) may be configurable or configured to perform voice and/or data communications through one or more networks (e.g., network 140) and/or telephone networks (e.g., telephone network 10), such as 3G networks, 4G networks, 4G LTE networks, or the like. In addition to or in replacement, the communication gateway server (e.g., processor 110) may be configurable or configured to perform voice and/or data communications via data networks and/or local area networks, such as wireless local area networks (WLANs) and/or via other forms, such as Bluetooth, NFC, and other forms of short or long range wireless signals. One or more of the aforementioned communications may be between example embodiments of the communication gateway server (e.g., processor 110) and one or more computing devices (e.g., computing device 120), telephones (e.g., device 20c), one or more other communication gateway servers (e.g., processor 110), one or more telephone networks (e.g., telephone network 10), and/or one or more networks (e.g., network 140).

In an example embodiment, the communication gateway server (e.g., processor 110) may be configurable or configured to receive, from one or more telephones and/or computing devices via one or more telephone networks (e.g., telephone network 10) and/or networks (e.g., network 140), one or more voice communications (e.g., telephone calls) to a telephone number (e.g., main telephone number 110′ illustrated in FIG. 1) assigned to, configured for, and/or subscribed by the communication gateway server (e.g., processor 110). As an example, if the communication gateway server (e.g., processor 110) is assigned a main telephone number (e.g., main telephone number 110′), a telephone call placed by computing device 20a to the main telephone number (e.g., main telephone number 110′) may follow the following signal path: from signal 102a to signal 106. Similarly, a telephone call placed by computing device 20b to the main telephone number (e.g., main telephone number 110′) may follow the following signal path: signal 102b to signal 106. Similarly, a telephone call placed by telephone 20c to the main telephone number (e.g., main telephone number 110′) may follow the following signal path: signal 102c to signal 106. Similarly, a telephone call placed by computing device 20d to the main telephone number (e.g., main telephone number 110′) may follow the following signal path: signal 102d to signal 104 to signal 106. Similarly, a telephone call placed by computing device 20e to the main telephone number (e.g., main telephone number 110′) may follow the following signal path: signal 102e to signal 104 to signal 106. Similarly, a telephone call placed by computing device 120a to the main telephone number (e.g., main telephone number 110′) may follow the following signal path: signal 102 to signal 106. It is to be understood in the present disclosure that a telephone call placed by or via the communication gateway server (e.g., processor 110) to any one or more of the aforementioned devices may follow a signal path that is the reverse of the aforementioned signal paths.

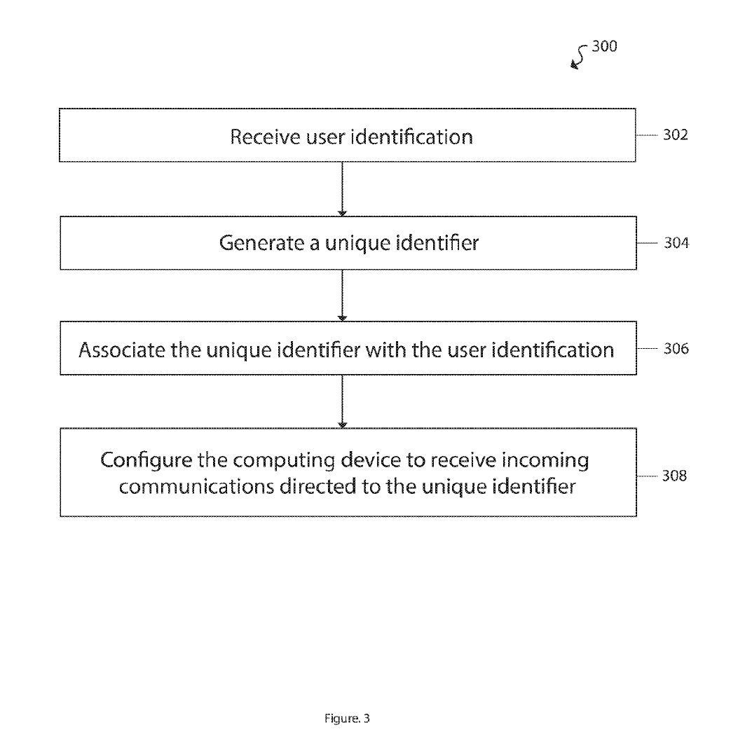

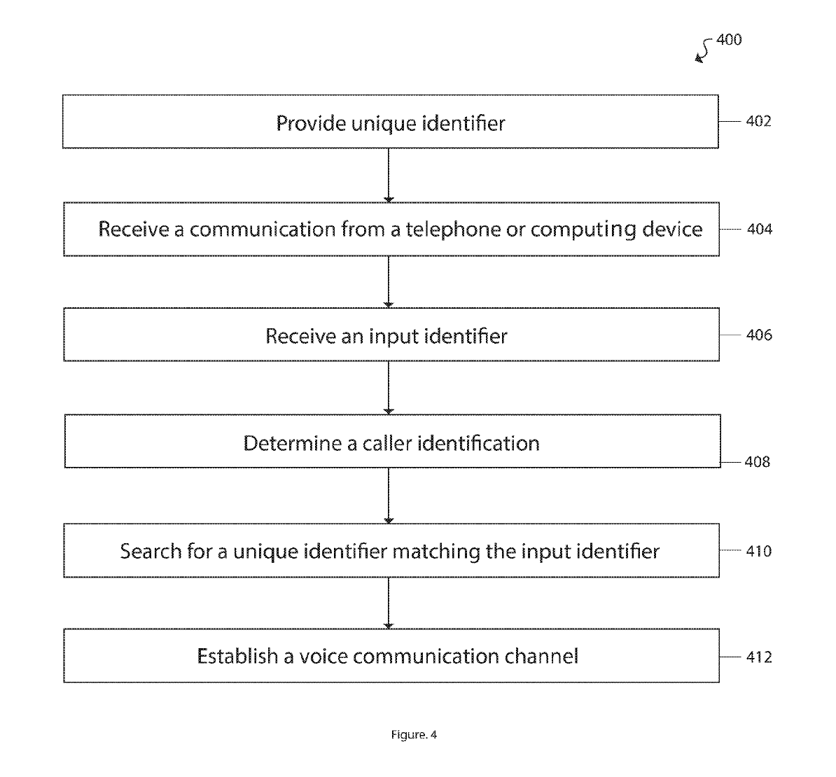

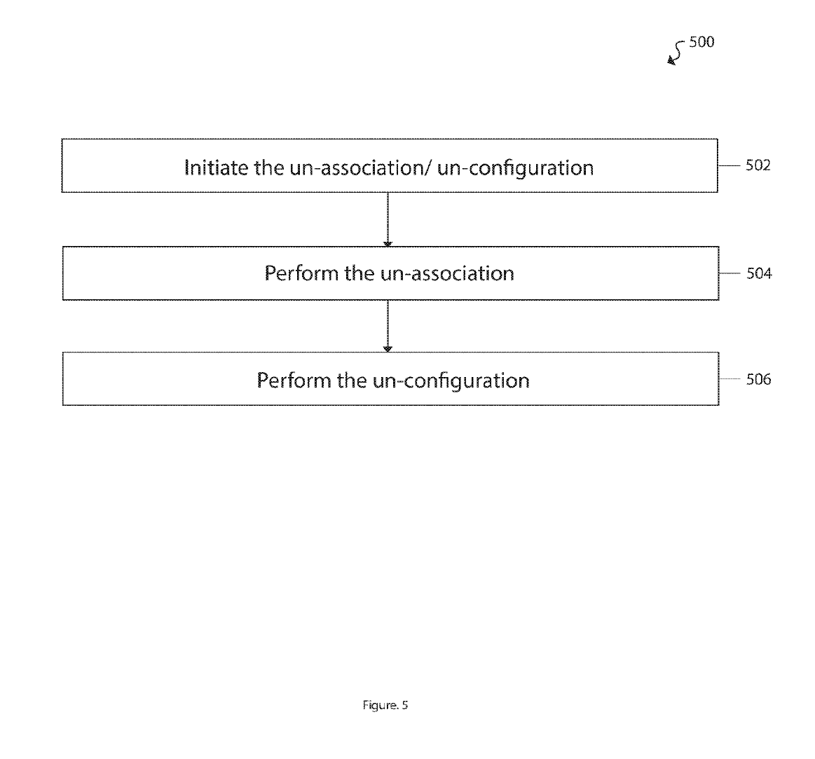

The communication gateway server (e.g., processor 110) may be configurable or configured to perform one or more of a plurality of processes, functions, and/or operations. In an example embodiment, as illustrated in FIG. 2 and FIG. 3, the communication gateway server (e.g., processor 110) may be configurable or configured to perform an association/configuration process (e.g., association/configuration process 300) so as to enable a computing device (e.g., computing device 120a, 120b, 120c, and/or 120d) to perform voice communications with a telephone (e.g., telephone 20c) and/or computing device (e.g., computing device 20a, 20b, 20d, and/or 20e). As illustrated in FIG. 2 and FIG. 4, the communication gateway server (e.g., processor 110) may also be configurable or configured to perform a directing/connecting process (e.g., directing/connecting process 400) so as to establish a communication channel between the computing device (e.g., computing device 120a, 120b, 120c, and/or 120d) and the telephone (e.g., telephone 20c) and/or computing device (e.g., computing device 20a, 20b, 20d, and/or 20e) and allow voice communications. As illustrated in FIG. 2 and FIG. 5, the communication gateway server (e.g., processor 110) may also be configurable or configured to perform a un-associating/un-configuring process (e.g., un-associating/un-configuring process 500) so as to un-associate any associated unique identifiers (e.g., first unique identifier) and/or user identifications (e.g., first user identification) from a computing device (e.g., computing device 120). These processes are further described below and in the present disclosure.

Association/Configuration Process (e.g., Association/Configuration Process 300).

As illustrated in at least FIGS. 2 and 3, an example embodiment of the communication gateway server (e.g., processor 110) may be configurable or configured to perform an association/configuration process (e.g., association/configuration process 300). The association/configuration process (e.g., association/configuration process 300) may be performed so as to enable a computing device (e.g., computing device 120a, 120b, 120c, and/or 120d) to perform voice communications, such as with telephone (e.g., telephone 20c) and/or computing device (e.g., computing device 20a, 20b, 20d, and/or 20e). The association/configuration process (e.g., association/configuration process 300) is further described below and in the present disclosure.

(i) Receiving a User Identification (e.g., Action 302).

The association/configuration process (e.g., association/configuration process 300) may include receiving, by the communication gateway server (e.g., processor 110), one or more user identifications (e.g., user identification 30 as illustrated in FIG. 2) (e.g., action 302). The user identification (e.g., a first user identification 30) may be information for use in identifying a user (e.g., a first user) who will be receiving a computing device (e.g., a first computing device 120a illustrated in FIG. 2).

For example, in a situation where a hotel operator provides a computing device (e.g., first computing device 120a) to a hotel guest for temporary use during the hotel guest's stay in the hotel, the user identification (e.g., first user identification 30) may include, but is not limited to, the full name of the hotel guest, date of birth of the hotel guest, passport number of the hotel guest, drivers license number of the hotel guest, credit card number of the hotel guest, hotel rewards account number for the hotel guest, account number generated for the hotel guest, an airline rewards account number for the hotel guest, email address of the hotel guest, social media name or handle of the hotel guest, residential address of the hotel guest, history of previous computing devices, user identification, and/or unique identifiers previously provided, assigned, and/or associated to the hotel guest, history of previous stays at the hotel and/or affiliated hotels, etc. The user identification (e.g., first user identification 30) may also include one or more of the above information for one or more accompanying persons. In an example embodiment, the user identification (e.g., user identification 30) may include a plurality of the aforementioned pieces of information, such as the full name of the hotel guest and date of birth of the hotel guest; full name of the hotel guest and hotel rewards account number of the hotel guest; and other combinations.

As another example, in a situation where an employer provides a computing device (e.g., first computing device 120a) to an employee, affiliate employee, contractor, customer, etc. for temporary use, the user identification (e.g., first user identification 30) may include, but is not limited to, the full name of the person, date of birth of the person, passport number of the person, drivers license number of the person, credit card number of the person, employee/vendor/customer number of the person, email address of the person, social media name or handle of the person, residential or business address of the person, history of computing devices, user identification, and/or unique identifiers previously provided, assigned, and/or associated to the person, etc. In an example embodiment, the user identification (e.g., user identification 30) may include a plurality of the aforementioned pieces of information, such as the full name of the person, date of birth of the person, and previous history of provided computing devices; full name of the person and employee/vendor/customer number of the person; and other combinations.

User identification (e.g., first user identification 30) for each user (e.g., first user) may be stored in a database (e.g., database 130) prior to and/or after the communication gateway server (e.g., processor 110) receives the user identification (e.g., first user identification 30).

(ii) Generating a Unique Identifier (e.g., Action 304).

As illustrated in FIGS. 2 and 3, the association/configuration process (e.g., association/configuration process 300) may include generating, selecting, assigning, and/or associating (hereinafter “generating”), by the communication gateway server (e.g., processor 110), a unique identifier for each of the received user identifications. For example, the association/configuration process (e.g., association/configuration process 300) may include generating a first unique identifier for the first user identification 30 (e.g., action 304).

The generating of the unique identifier (e.g., first unique identifier) may be performable by a generator (e.g., generator 110a illustrated in FIG. 2) and/or another element or functionality of the communication gateway server (e.g., processor 110) in example embodiments. The generator (e.g., generator 110a) may include or be a part of the communication gateway server (e.g., processor 110), a virtual machine, processor, computer, computing device, node, instance, host, and/or machine in a networked computing environment. The generator (e.g., generator 110a) may also be a functionality of the communication gateway server (e.g., processor 110).

As used in the present disclosure, a unique identifier (e.g., first unique identifier) generated for a user identification (e.g., first user identification) and a computing device (e.g., first computing device 120a to be provided to the first user) may be any identifier, including a series of numbers and/or characters, a spoken word, an image, and/or an action, that may be used by or performed on a telephone (e.g., device 20c), other computing devices (e.g., computing devices 20a, 20b, 20d, 20e), and/or the communication gateway server (e.g., processor 110) to initiate, direct, and/or perform voice communications (e.g., telephone calls) with the computing device (e.g., first computing device 120a). In an example embodiment, each unique identifier (e.g., first unique identifier) may be partially or wholly randomly generated, and such random generation of each unique identifier (e.g., first unique identifier) may be based on one or more conditions, as further described in the present disclosure. In another example embodiment, the unique identifier (e.g., first unique identifier) may be spoken words. In another example embodiment, the unique identifier (e.g., first unique identifier) may be an image, symbol, and/or code (e.g., a QR code, bar code, photo of the user, etc.).

In an example embodiment, the generating of the unique identifier (e.g., first unique identifier) may be performed in such a way as to exclude or not consider some or all unique identifiers that are currently associated and/or planned/scheduled to be associated with other user identifications (e.g., filter 34 illustrated in FIG. 2). That is, the unique identifier (e.g., first unique identifier) may be generated based on a check, by the generator (e.g., generator 110a) and/or another element or functionality of the communication gateway server (e.g., processor 110), that the unique identifier (e.g., first unique identifier) is not currently associated and/or planned/scheduled to be associated with any user identification (e.g., filter 34).

In addition to or in replacement, the generating of the unique identifier (e.g., first unique identifier) may be performed in such a way as to exclude or not consider some or all unique identifiers that have been associated and/or are planned/scheduled to be associated with any user identification during a specified period of time (e.g., filter 32). The specified period of time may be any period of time, such as within the last one month, within the last six months, within the last year, within the last two years, or for all periods of time (e.g., as far back as the database (e.g., database 130) stores and/or as far back as the communication gateway server (e.g., processor 110) can search).

Other additional or replacement conditions and/or requirements for the generating of each unique identifier are also contemplated in the present disclosure. For example, the generating of the unique identifier (e.g., first unique identifier) may be performed in such a way as to exclude or not consider some or all unique identifiers that were previously associated and/or are planned/scheduled to be associated, during the specified period of time, to the user (e.g., first user) who is receiving the computing device and/or to the user identification (e.g., first user identification 30) of the user (e.g., first user). In addition to or in replacement, the generating of the unique identifier (e.g., first unique identifier) may be performed in such a way as to only include or consider some or all unique identifiers that were previously associated and/or planned/scheduled to be associated, during the specified period of time, to the user (e.g., first user) who is receiving the computing device and/or to the user identification (e.g., first user identification 30) of the user (e.g., first user). In addition to or in replacement, the generating of the unique identifier (e.g., first unique identifier) may be performed in such a way as to only include (or exclude) or consider (or not consider) some or all unique identifiers that were previously associated and/or are planned/scheduled to be associated, during the specified period of time, to a particular type of user or user identification, such as those having the same or different employer, those having the same or different city/country of residence, those having the same or different nationality, etc.

Each generated unique identifier (e.g., first unique identifier) may be stored in a database (e.g., database 130). Furthermore, the conditions and/or requirements applied in the generating of each unique identifier (e.g., first unique identifier) may also be stored in a database (e.g., database 130).

(iii) Associating the Unique Identifier with the User Identification (e.g., Action 306).

As illustrated in FIGS. 2 and 3, the association/configuration process (e.g., association/configuration process 300) may include associating, by the communication gateway server (e.g., processor 110), each of the generated unique identifiers with a received user identification. For example, the association/configuration process (e.g., association/configuration process 300) may include associating the generated first unique identifier with the first user identification 30 of the first user (e.g., action 306).

The associating of the unique identifier (e.g., first unique identifier) with the user identification (e.g., first user identification 30) may be performable by an associator/configurator (e.g., associator/configurator 110b illustrated in FIG. 2) in example embodiments. The associator/configurator (e.g., associator/configurator 110b) may include or be a part of the communication gateway server (e.g., processor 110), a virtual machine, processor, computer, node, instance, host, and/or machine in a networked computing environment. The associator/configurator (e.g., associator/configurator 110b) may also be a functionality of the communication gateway server (e.g., processor 110).

Each association of a unique identifier (e.g., first unique identifier) with a user identification (e.g., first user identification 30) may be stored in a database (e.g., database 130).

The association/configuration process (e.g., association/configuration process 300) may also include associating, by the associator/configurator (e.g., associator/configurator 110b) and/or another element or functionality of the communication gateway server (e.g., processor 110), each of the generated unique identifiers with a computing device (e.g., computing device 120). For example, the association/configuration process (e.g., association/configuration process 300) may include associating the first unique identifier with a first computing device (e.g., first computing device 120a). The associating of the unique identifier (e.g., first unique identifier) with the computing device (e.g., first computing device 120a) may be performable by the associator/configurator (e.g., associator/configurator 110b) and/or another element or functionality of the communication gateway server (e.g., processor 110) in example embodiments. Furthermore, each association of a unique identifier (e.g., first unique identifier) with a computing device (e.g., first computing device 120a) may be stored in a database (e.g., database 130).

The association/configuration process (e.g., association/configuration process 300) may also include associating, by the associator/configurator (e.g., associator/configurator 110b) and/or another element or functionality of the communication gateway server (e.g., processor 110), each of the received user identifications with a computing device (e.g., computing device 120). For example, the association/configuration process (e.g., association/configuration process 300) may include associating the first user identification 30 with a first computing device (e.g., first computing device 120a). The associating of the user identification (e.g., first user identification 30) with the computing device (e.g., first computing device 120a) may be performable by the associator/configurator (e.g., associator/configurator 110b) and/or another element or functionality of the communication gateway server (e.g., processor 110) in example embodiments. Furthermore, each association of a user identification (e.g., first user identification 30) with a computing device (e.g., first computing device 120a) may be stored in a database (e.g., database 130).

The association/configuration process (e.g., association/configuration process 300) may also include configuring, by the associator/configurator (e.g., associator/configurator 110b) and/or another element or functionality of the communication gateway server (e.g., processor 110), each of the computing devices (e.g., computing device 120). For example, the association/configuration process (e.g., association/configuration process 300) may include configuring the first computing device 120a (e.g., action 308). Such configuring may include, but is not limited to, configuring the computing device (e.g., first computing device 120a) to receive communications (e.g., voice communications) directed to the unique identifier (e.g., first unique identifier). For example, the configuring of the computing device (e.g., first computing device 120a) may include providing, assigning, loading, installing, and/or storing the generated unique identifier (e.g., first unique identifier) to the computing device (e.g., first computing device 120a) and configuring the computing device (e.g., first computing device 120a) to receive communications (e.g., voice communications) directed to the unique identifier (e.g., first unique identifier). The configuring may also include assigning the user identification (e.g., first user identification 30) to the computing device (e.g., first computing device 120a). The configuring of the computing device (e.g., first computing device 120a) may be performable by the associator/configurator (e.g., associator/configurator 110b illustrated in FIG. 2) and/or another element or functionality of the communication gateway server (e.g., processor 110) in example embodiments.

As a non-limiting example, the computing device (e.g., first computing device 120a) may have installed in it (or via cloud computing) a software application or functionality, such as a VoIP application or functionality, or the like. The configuring of the computing device (e.g., first computing device 120a) may include providing, assigning, loading, installing, and/or storing the unique identifier (e.g., first unique identifier) to the VoIP application or functionality and configuring the VoIP application or functionality to receive voice communications directed to the unique identifier (e.g., first unique identifier).

Directing/Connecting Process (e.g., Directing/Connecting Process 400).

As illustrated in FIGS. 2 and 4, an example embodiment of the communication gateway server (e.g., processor 110) may be configurable or configured to perform a directing/connecting process (e.g., directing/connecting process 400). The directing/connecting process (e.g., directing/connecting process 400) may be performable, such as via a director/connector (e.g., director/connector 110c as illustrated in FIG. 2) and/or another element or functionality of the communication gateway server (e.g., processor 110), so as to enable a directing, bridging, forwarding, and/or connecting of a voice communication (e.g., a telephone call) originating from a telephone (e.g., telephone 20c) and/or computing device (e.g., computing device 20a, 20b, 20d, and/or 20e) to a computing device (e.g., first computing device 120a and/or computing devices 120b, 120c, and/or 120d). Such directing, bridging, forwarding, and/or connecting of a voice communication may be via establishing a communication channel, such as a voice communication channel. The director/connector (e.g., director/connector 110c) may include or be a part of the communication gateway server (e.g., processor 110), a virtual machine, processor, computer, node, instance, host, and/or machine in a networked computing environment. The director/connector (e.g., director/connector 110c) may also be a functionality of the communication gateway server (e.g., processor 110).

The directing/connecting process (e.g., directing/connecting process 400) is further described below and in the present disclosure.

(i) Providing Unique Identifier to Others (e.g., Action 402).

After completing the association/configuration process (e.g., association/configuration process 300) for a computing device (e.g., first computing device 120a), the generated unique identifier (e.g., first unique identifier) associated with the user identification (e.g., first user identification) and/or computing device (e.g., first computing device 120a) may be provided to others, such as friends, contacts, and/or others who may need to perform voice communications with the user (e.g., first user) via the computing device (e.g., first computing device 120a).

(ii) Receiving a Communication from a Telephone or Computing Device (e.g., Action 404).

Once a computing device (e.g., first computing device 120a) has been configured, as described above and in the present disclosure, to receive voice communications (e.g., telephone calls) directed to a unique identifier (e.g., first unique identifier), a voice communication (e.g., telephone call) may be initiated by a telephone (e.g., device 20a, 20b, 20c, 20d, and/or 20e as illustrated in FIGS. 1 and 2) or computing device (e.g., computing device 20a, 20b, 20d, 20e, 120b, 120c, and/or 120d) to the computing device (e.g., first computing device 120a or computing device 120b, 120c, and/or 120d). For example, the telephone (e.g., device 20c) or computing device (e.g., computing device 20a, 20b, 20d, 20e, 120b, 120c, and/or 120d) may dial the main telephone number (e.g., main telephone number 110′) of the communication gateway server (e.g., processor 110), as described above and in the present disclosure. Upon dialing the main telephone number (e.g., main telephone number 110′), the director/connector (e.g., director/connector 110c) and/or another element or functionality of the communication gateway server (e.g., processor 110) may receive the voice communication (e.g., telephone call) from the telephone (e.g., device 20c) or computing device (e.g., computing device 20a, 20b, 20d, 20e, 120b, 120c, and/or 120d).

(iii) Receiving an Input Identifier (e.g., Action 406).

In an example embodiment, upon receiving the voice communication (e.g., telephone call), the director/connector (e.g., director/connector 110c) and/or another element or functionality of the communication gateway server (e.g., processor 110) may be configurable or configured to request or prompt the telephone (e.g., device 20c) or computing device (e.g., computing device 20a, 20b, 20d, 20e, 120b, 120c, and/or 120d) to provide an input identifier (e.g., a first input identifier).

As used in the present disclosure, an input identifier (e.g., first input identifier) providable or provided by the telephone (e.g., device 20c) or computing device (e.g., computing device 20a, 20b, 20d, 20e, 120b, 120c, and/or 120d) to the director/connector (e.g., director/connector 110c) and/or another element or functionality of the communication gateway server (e.g., processor 110) may be any identifier, including a series of numbers and/or characters and/or spoken words. For example, the director/connector (e.g., director/connector 110c) and/or another element or functionality of the communication gateway server (e.g., processor 110) may be configurable or configured in such a way as to allow the telephone (e.g., device 20c) or computing device (e.g., computing device 20a, 20b, 20d, 20e, 120b, 120c, and/or 120d) to provide the input identifier by pressing keys on a virtual or physical keypad or keyboard of the telephone (e.g., device 20c) or computing device (e.g., computing device 20a, 20b, 20d, 20e, 120b, 120c, and/or 120d). In addition to or alternatively, the director/connector (e.g., director/connector 110c) and/or another element or functionality of the communication gateway server (e.g., processor 110) may be configurable or configured in such a way as to allow the telephone (e.g., device 20c) or computing device (e.g., computing device 20a, 20b, 20d, 20e, 120b, 120c, and/or 120d) to provide the input identifier by way of speaking (e.g., voice or speech recognition, interactive voice response (IVR) technology, etc.). In addition to or alternatively, the director/connector (e.g., director/connector 110c) and/or another element or functionality of the communication gateway server (e.g., processor 110) may be configurable or configured in such a way as to allow the telephone (e.g., device 20c) or computing device (e.g., computing device 20a, 20b, 20d, 20e, 120b, 120c, and/or 120d) to provide the input identifier by way of interacting with an application, web interface, etc. so as to provide an image, code (e.g., QR code), symbol, etc. (e.g., signal 108d illustrated in FIG. 2). Such providing of the input identifier in the form of an image, code, symbol, etc. may be performed before and/or during the call (e.g., signal 108e illustrated in FIG. 2).

Upon receiving the input identifier from the telephone (e.g., device 20c) or computing device (e.g., computing device 20a, 20b, 20d, 20e, 120b, 120c, and/or 120d), the director/connector (e.g., director/connector 110c) and/or another element or functionality of the communication gateway server (e.g., processor 110) may be configurable or configured to perform one or more operations, including those described below and in the present disclosure.

(iv) Determining a Caller Identification (e.g., Action 408).

In an example embodiment, the director/connector (e.g., director/connector 110c) and/or another element or functionality of the communication gateway server (e.g., processor 110) may be configurable to determine information pertaining to the received voice communication (e.g., incoming voice call), including a caller identification (e.g., telephone number, name of caller, etc.) of the telephone (e.g., device 20c) or computing device (e.g., computing device 20a, 20b, 20d, 20e, 120b, 120c, and/or 120d) that initiated the voice communication (e.g., incoming voice call).

Upon determining the caller identification of the telephone (e.g., device 20c) or computing device (e.g., computing device 20a, 20b, 20d, 20e, 120b, 120c, and/or 120d) that initiated the voice communication (e.g., incoming voice call), the director/connector (e.g., director/connector 110c) and/or another element or functionality of the communication gateway server (e.g., processor 110) may be configurable or configured to store the caller identification and received input identifier, such as in a database (e.g., database 130). The director/connector (e.g., director/connector 110c) and/or another element or functionality of the communication gateway server (e.g., processor 110) may also be configurable or configured to associate the caller identification to the received input identifier, and store the association, such as in a database (e.g., database 130).

(v) Searching for a Unique Identifier Matching the Input Identifier (e.g., Action 410).

In an example embodiment, the director/connector (e.g., director/connector 110c) and/or another element or functionality of the communication gateway server (e.g., processor 110) may also be configurable or configured to perform a determination of whether the received input identifier (e.g., first input identifier) matches a unique identifier (e.g., first unique identifier). In performing the determination, the director/connector (e.g., director/connector 110c) and/or another element or functionality of the communication gateway server (e.g., processor 110) may limit the determination to certain unique identifiers, that is, perform a search based only on certain unique identifiers.

For example, the director/connector (e.g., director/connector 110c) and/or another element or functionality of the communication gateway server (e.g., processor 110) may perform the determination of whether the received input identifier (e.g., first input identifier) matches a unique identifier (e.g., first unique identifier) based on currently associated unique identifiers, that is, those unique identifiers that are currently associated with (and/or not yet un-associated from) a user identification and/or computing device. In this example, the determination may exclude or not consider those unique identifiers that have never been associated with a user identification and/or computing device. Furthermore, the determination may exclude or not consider those unique identifiers that were previously associated, but currently not associated, with a user identification and/or computing device.

In addition to or in replacement, the director/connector (e.g., director/connector 110c) and/or another element or functionality of the communication gateway server (e.g., processor 110) may perform the determination of whether the received input identifier (e.g., first input identifier) matches a unique identifier (e.g., first unique identifier) based on previously associated unique identifiers. For example, the determination may be based on those unique identifiers that were previously associated with (and/or have been un-associated from) a user identification and/or computing device. In this example, the determination may exclude or not consider those unique identifiers that have never been associated with a user identification and/or computing device.

In addition to or in replacement, the director/connector (e.g., director/connector 110c) and/or another element or functionality of the communication gateway server (e.g., processor 110) may perform the determination of whether the received input identifier (e.g., first input identifier) matches a unique identifier (e.g., first unique identifier) based on the caller identification of the telephone (e.g., device 20c) or computing device (e.g., computing device 20a, 20b, 20d, 20e, 120b, 120c, and/or 120d) that initiated the voice communication.

For example, a match may be determined by the director/connector (e.g., director/connector 110c) and/or another element or functionality of the communication gateway server (e.g., processor 110) when the director/connector (e.g., director/connector 110c) and/or another element or functionality of the communication gateway server (e.g., processor 110) determines that the caller identification of the voice communication (e.g., incoming or current voice call) had not previously called the unique identifier (e.g., first unique identifier) before the unique identifier (e.g., first unique identifier) was associated with the user identification (e.g., first user identification).

As another example, the determination may be based on those input identifiers and/or unique identifiers that are or were previously associated with the caller identification of the outside caller (i.e., input identifiers previously provided by the caller identification in previously calls). Put differently, the determination may be based on a history of those input identifiers and/or unique identifiers the outside caller (i.e., the caller identification identified in the incoming voice call) had previously called. In such an example, if the outside caller (i.e., the caller identification identified in the incoming voice call) had previously called a first unique identifier (e.g., first unique identifier associated with a first user identification) by providing the first unique identifier as the input identifier, the director/connector (e.g., director/connector 110c) and/or another element or functionality of the communication gateway server (e.g., processor 110) would have performed an association of that input identifier (i.e., the first unique identifier) with the caller identification of the outside caller at that time. On a subsequent call initiated by the same caller identification, if the input identifier entered by the caller is the first unique identifier but the first user identification (that was previously associated to the first unique identifier) has since been un-associated from the first unique identifier and now associated with a second unique identifier (different from the first unique identifier), the director/connector (e.g., director/connector 110c) and/or another element or functionality of the communication gateway server (e.g., processor 110) may consider the input identifier to match the second unique identifier and/or proceed to establish a voice communication channel between the incoming voice call and the computing device associated with the second unique identifier.

(vi) Establishing a Voice Communication Channel (e.g., Action 414).

In an example embodiment, the director/connector (e.g., director/connector 110c) and/or another element or functionality of the communication gateway server (e.g., processor 110) may be configurable or configured to establish a voice communication channel between the voice communication (e.g., incoming voice call) initiated by the telephone (e.g., device 20c) or computing device (e.g., computing device 20a, 20b, 20d, 20e, 120b, 120c, and/or 120d) and the computing device (e.g., first computing device 120a) associated with the unique identifier (e.g., first unique identifier) and/or user identification (e.g., first user identification) based on one or more of the conditions described above and in the present disclosure. The voice communication channel established by the director/connector (e.g., director/connector 110c) and/or another element or functionality of the communication gateway server (e.g., processor 110) may be a VoIP channel in example embodiments.

Un-Association/Un-Configuration Process (e.g., Un-Association/Un-Configuration Process 500).

As illustrated in at least FIG. 5, an example embodiment of the communication gateway server (e.g., processor 110) may be configurable or configured to perform an un-association/un-configuration process (e.g., un-association/un-configuration process 500). The un-association/un-configuration process (e.g., un-association/un-configuration process 500) may be performed so as to reset, un-associate, and/or un-configure a computing device (e.g., computing device 120a, 120b, 120c, and/or 120d), and/or disable a computing device (e.g., computing device 120a, 120b, 120c, and/or 120d) from perform voice communications, such as with telephone (e.g., telephone 20c) and/or computing device (e.g., computing device 20a, 20b, 20d, and/or 20e). The un-association/un-configuration process (e.g., un-association/un-configuration process 500) is further described below and in the present disclosure.

(i) Initiating the Un-Association/Un-Configuration (e.g., Action 502).

The un-association/un-configuration process (e.g., un-association/un-configuration process 500) may include initiating the un-association/un-configuring (e.g., action 502). The initiating may including receiving, by the communication gateway server (e.g., processor 110), a command to reset, un-associate, un-configure, and/or disable a computing device (e.g., computing device 120) (e.g., action 502). Such command may be received directly by a user (e.g., if the user loses the computing device (e.g., computing device 120), etc.), directly by an administrator (e.g., if the user loses the computing device (e.g., computing device 120) or any other reason why the administrator will need to end voice communication capabilities for the computing device (e.g., computing device 120)), based on a pre-scheduled action (e.g., in the case of a hotel guest, upon a scheduled check-out of the hotel guest, etc.), based on an event occurring (e.g., in the case of a school or university, upon a student being removed as an enrolled student; in the case of a hotel, upon a hotel guest checking out early, checking out as scheduled, losing the computing device (e.g., computing device 120), etc.), and/or in other ways.

For example, in a situation where a hotel provides a computing device (e.g., computing device 120) to a hotel guest for use during the hotel guest's stay at the hotel, the un-association/un-configuring process for the computing device (e.g., computing device 120) may be initiated, by the communication gateway server (e.g., processor 110), based on a scheduled check-out date and time of the hotel guest. The scheduled check-out date and time may be stipulated in, for example, the database (e.g., database 130), the communication gateway server (e.g., processor 110), and/or the hotel's computer systems. Alternatively, the un-association/un-configuring process for the computing device (e.g., computing device 120) may be initiated based on a command provided or initiated by an administrator (e.g., hotel employee) to the communication gateway server (e.g., processor 110), such as upon payment or settling of any hotel charges by the hotel guest at the time of check-out. Alternatively, the un-association/un-configuring process for the computing device (e.g., computing device 120) may be initiated, by the communication gateway server (e.g., processor 110), upon the hotel guest placing the computing device (e.g., computing device 120) on a dedicated docking/charging station in the hotel guest's hotel room, departing from the hotel guest's hotel room (e.g., after removing a hotel key card, etc.), and/or expiry of a specific date and time.

As another example, in a situation where an employer provides a computing device (e.g., computing device 120) to an employee for temporary use, the un-association/un-configuring process for the computing device (e.g., computing device 120) may be initiated, by the communication gateway server (e.g., processor 110), based on a scheduled date and time. The scheduled date and time may be stipulated in, for example, the database (e.g., database 130), the communication gateway server (e.g., processor 110), and/or the employer's computer systems. Alternatively, the un-association/un-configuring process for the computing device (e.g., computing device 120) may be initiated based on a command provided or initiated by an administrator (e.g., employer's IT team) to the communication gateway server (e.g., processor 110), such as upon changing of the status of the employee. Alternatively, the un-association/un-configuring process for the computing device (e.g., computing device 120) may be initiated, by the communication gateway server (e.g., processor 110), upon the employee placing the computing device (e.g., computing device 120) on a dedicated docking/charging station in the employee's office and/or expiry of a specific date and time.

A specified date and time for initiating the un-association/un-configuration process for each user (e.g., first user), computing device (e.g., computing device 120), unique identifier, user identification, and/or association of one or more of these may be stored in a database (e.g., database 130).

(ii) Performing the Un-Associating/Un-Configuring Process (e.g., Action 504).

As illustrated in FIGS. 2 and 5, the un-association/un-configuration process (e.g., un-association/un-configuration process 500) may include un-associating, by the communication gateway server (e.g., processor 110), a unique identifier from a user identification. For example, the un-association/un-configuration process (e.g., un-association/un-configuration process 500) may include un-associating the first unique identifier from the first user identification 30 of the first user (e.g., action 504).

The un-associating of the unique identifier (e.g., first unique identifier) from the user identification (e.g., first user identification 30) may be performable by an un-associator/un-configurator (not shown), the associator/configurator (e.g., associator/configurator 110b illustrated in FIG. 2), and/or another element or functionality of the communication gateway server (e.g., processor 110) in example embodiments. The un-associator/un-configurator may include or be a part of the communication gateway server (e.g., processor 110), a virtual machine, processor, computer, node, instance, host, and/or machine in a networked computing environment. The un-associator/un-configurator may also be a functionality of the communication gateway server (e.g., processor 110).

Each un-association of a unique identifier (e.g., first unique identifier) from a user identification (e.g., first user identification 30) may be stored in a database (e.g., database 130).

The un-association/un-configuration process (e.g., un-association/un-configuration process 500) may also include un-associating, by the un-associator/un-configurator and/or other element or functionality of the communication gateway server (e.g., processor 110), each of the unique identifiers from a computing device (e.g., computing device 120). For example, the un-association/un-configuration process (e.g., un-association/un-configuration process 500) may include un-associating the first unique identifier from a first computing device (e.g., first computing device 120a). The un-associating of the unique identifier (e.g., first unique identifier) from the computing device (e.g., first computing device 120a) may be performable by the un-associator/un-configurator, the associator/configurator (e.g., associator/configurator 110b), and/or another element or functionality of the communication gateway server (e.g., processor 110) in example embodiments. Furthermore, each un-association of a unique identifier (e.g., first unique identifier) from a computing device (e.g., first computing device 120a) may be stored in a database (e.g., database 130).

The un-association/un-configuration process (e.g., un-association/un-configuration process 500) may also include un-associating, by the un-associator/un-configurator and/or other element or functionality of the communication gateway server (e.g., processor 110), each of the user identifications from a computing device (e.g., computing device 120). For example, the un-association/un-configuration process (e.g., un-association/un-configuration process 500) may include un-associating the first user identification 30 from a first computing device (e.g., first computing device 120a). The un-associating of the user identification (e.g., first user identification 30) from the computing device (e.g., first computing device 120a) may be performable by the un-associator/un-configurator, the associator/configurator (e.g., associator/configurator 110b), and/or another element or functionality of the communication gateway server (e.g., processor 110) in example embodiments. Furthermore, each un-association of a user identification (e.g., first user identification 30) from a computing device (e.g., first computing device 120a) may be stored in a database (e.g., database 130).

The un-association/un-configuration process (e.g., un-association/un-configuration process 500) may also include un-configuring, by the un-associator/un-configurator and/or other element or functionality of the communication gateway server (e.g., processor 110), each of the computing devices (e.g., computing device 120). For example, the un-association/un-configuration process (e.g., un-association/un-configuration process 500) may include un-configuring the first computing device 120a (e.g., action 506). Such un-configuring may include, but is not limited to, un-configuring the computing device (e.g., first computing device 120a) so as to no longer receive communications (e.g., voice communications) directed to the unique identifier (e.g., first unique identifier). For example, the un-configuring of the computing device (e.g., first computing device 120a) may include removing, un-assigning, un-installing, and/or deleting the unique identifier (e.g., first unique identifier) from the computing device (e.g., first computing device 120a) and configuring the computing device (e.g., first computing device 120a) to no longer receive communications (e.g., voice communications) directed to the unique identifier (e.g., first unique identifier). The un-configuring may also include un-assigning the user identification (e.g., first user identification 30) from the computing device (e.g., first computing device 120a). The un-configuring of the computing device (e.g., first computing device 120a) may be performable by the un-associator/un-configurator, associator/configurator (e.g., associator/configurator 110b illustrated in FIG. 2), and/or another element or functionality of the communication gateway server (e.g., processor 110) in example embodiments.

As a non-limiting example, the computing device (e.g., first computing device 120a) may have installed in it (or via cloud computing) a software application or functionality, such as a VoIP application or functionality, or the like. The un-configuring of the computing device (e.g., first computing device 120a) may include removing, un-assigning, un-installing, and/or deleting the unique identifier (e.g., first unique identifier) from the VoIP application or functionality and un-configuring the VoIP application or functionality from receiving voice communications directed to the unique identifier (e.g., first unique identifier).

### Example 1

In an example embodiment, a method of managing voice communications may include receiving, at a communication gateway server (e.g., processor 110), a first user identification, as described above and in the present disclosure. The method may also include receiving a first specified time period (or condition or event) for enabling voice communications on a first computing device (e.g., computing device 120) for the first user identification, as described above and in the present disclosure. In the case of a hotel situation, the first specified time period may be a period during which the hotel guest will be staying at the hotel and/or a period leading up to a check-out date of the hotel guest.

The method may further include associating, by the communication gateway server (e.g., processor 110), a first unique identifier with the first computing device (e.g., computing device 120), as described above and in the present disclosure. For example, the first unique identifier may be a series of numbers resembling a telephone extension (e.g., 2-5 digit series of numbers). Alternatively, the first unique identifier may be a series of characters and/or a combination of numbers and characters.

The method may further include associating, by the communication gateway server (e.g., processor 110), the first unique identifier with the first user identification, as described above and in the present disclosure. For example, the first user identification may include a full name of a user that will receive the first computing device (e.g., computing device 120), date of birth of the user, drivers license number of the user, passport number of the user, special account number of the user (e.g., hotel rewards number, airline rewards number, employee number, etc.), as described above and in the present disclosure.

The method may further include configuring, by the communication gateway server (e.g., processor 110), the first computing device (e.g., computing device 120) to selectively or dynamically receive incoming voice communications directed to the first unique identifier, as described above and in the present disclosure. For example, the first computing device (e.g., computing device 120) may be configured with the first unique identifier, the first user identification, and/or association between the first unique identifier, the first user identification, and/or the first computing device (e.g., computing device 120). The selective or dynamic receiving may be a receiving based on one or more information, conditions, requirements, and/or checks that are historic, current, and/or continuously changing (i.e., dynamic), as described above and in the present disclosure. For example, a first unique identifier of a first user assigned a first computing device (e.g., computing device) may dynamically change during the first specified period of time (e.g., if an outside caller calls the first unique identifier intending to reach a previous user) and/or the first user may have dynamically associated with his/her first user identification and/or first computing device (e.g., computing device 120) more than one first unique identifiers based on, among other things, the caller identification of the outside caller, area code of the caller identification of the outside caller, day or time of the day, etc.

The method may further include un-associating, by the communication gateway server (e.g., processor 110), the first unique identifier from the first computing device, as described above and in the present disclosure. The method may further include un-associating, by the communication gateway server (e.g., processor 110), the first user identification upon lapse, expiry, or satisfying of the first specified time period, as described above and in the present disclosure. For example, the first user having the first user identification may no longer be assigned the first computing device and/or no longer need the first computing device. As a more specific example, the first user may be a hotel guest who has or is about to check out of the hotel.

The method may further include receiving, at the communication gateway server (e.g., processor 110), a second user identification for enabling voice communications on the first computing device (e.g., computing device 120) for the second user identification, as described above and in the present disclosure. The method may further include receiving, at the communication gateway server (e.g., processor 110), a second specified time period for enabling voice communications on the first computing device (e.g., computing device 120) for the second user identification, as described above and in the present disclosure. For example, in the hotel situation, a second hotel guest (second user) may be checking into the hotel and the hotel may be assigning the same first computing device to the second user.

The method may further include associating, by the communication gateway server (e.g., processor 110), a second unique identifier with the first computing device (e.g., computing device 120), as described above and in the present disclosure. The method may further include associating, by the communication gateway server (e.g., processor 110), the second unique identifier with the second user identification, as described above and in the present disclosure. To prevent unwanted calls to the second user from outside callers who previously called the first user (via the first unique identifier) on the first computing device, a second unique identifier different from the first unique identifier is assigned to/associated with the second user.

The method may further include configuring, by the communication gateway server (e.g., processor 110), the first computing device (e.g., computing device 120) to selectively receive incoming voice communications directed to the second unique identifier. The selective receiving may be a receiving based on one or more conditions, requirements, and/or checks, as described above and in the present disclosure.

The method may further include un-associating, by the communication gateway server (e.g., processor 110), the second unique identifier from the first computing device (e.g., computing device 120), as described above and in the present disclosure. The method may further include un-associating, by the communication gateway server (e.g., processor 110), the second user identification upon lapse, expiry, or satisfying of the second specified time period, as described above and in the present disclosure. For example, the second user having the second user identification may no longer be assigned the first computing device and/or no longer need the first computing device. As a more specific example, the second user may be a hotel guest who has or is about to check out of the hotel.

In this example embodiment, the method further includes receiving, at the communication gateway server (e.g., processor 110), a first incoming voice call, as described above and in the present disclosure. Thereafter, the method may include determining, by the communication gateway server (e.g., processor 110), a caller identification of the first incoming voice call, as described above and in the present disclosure. The method may further include receiving, at the communication gateway server (e.g., processor 110), a first input identifier for the first incoming voice call, as described above and in the present disclosure. The method may further include establishing, by the communication gateway server (e.g., processor 110), a voice communication channel to connect the first incoming voice call to the first computing device (e.g., computing device 120) when the communication gateway server (e.g., processor 110) determines that: (i) the first computing device (e.g., computing device 120) is configured to receive incoming voice communications directed to the first unique identifier, the first specified time period has not yet lapsed, the first input identifier received for the first incoming voice call matches the first unique identifier, and the caller identification of the first incoming voice call has not previously called the first unique identifier before the first unique identifier was associated with the first user identification, as described above and in the present disclosure; or (ii) the first computing device (e.g., computing device 120) is configured to receive incoming voice communications directed to the second unique identifier, the second specified time period has not yet lapsed, the first input identifier received for the first incoming voice call matches the second unique identifier, and the caller identification of the first incoming voice call has not previously called the second unique identifier before the second unique identifier was associated with the second user identification, as described above and in the present disclosure.

In an example embodiment, when the first unique identifier is associated with the first computing device (e.g., computing device 120) and/or the first user identification, the first computing device (e.g., computing device 120) may selectively or dynamically receive a first incoming voice call directed to the first unique identifier when a determination is made, by the communication gateway server (e.g., processor 110), that a caller identification of the first incoming voice call has not previously called the first unique identifier before the first unique identifier was associated with the first user identification, as described above and in the present disclosure.

In an example embodiment, when the first unique identifier is associated with the first computing device (e.g., computing device 120) and/or the first user identification, the first computing device (e.g., computing device 120) may selectively or dynamically receive a first incoming voice call directed to the first unique identifier when the communication gateway server (e.g., processor 110) determines that a caller identification of the first incoming voice call was involved with establishing a previous voice communication channel via a third unique identifier and the third unique identifier was associated with the first user identification at the time the previous voice communication channel was established, as described above and in the present disclosure. The third unique identifier may be different from the first unique identifier.

In this example embodiment, the first unique identifier may be a randomly generated number, and the second unique identifier may be a randomly generated number, as described above and in the present disclosure. The first incoming voice call may be a telephone call to a telephone number assigned to the communication gateway server (e.g., processor 110), as described above and in the present disclosure. Furthermore, the caller identification of the first incoming voice call may be a telephone number that placed the first incoming voice call to the telephone number assigned to the communication gateway server (e.g., processor 110), as described above and in the present disclosure. Furthermore, the first input identifier for the first incoming voice call may be received after the communication gateway server (e.g., processor 110) answers the first incoming voice call, as described above and in the present disclosure. Furthermore, the voice communication channel is a VoIP channel, as described above and in the present disclosure.

### Example 2

In another example embodiment, a method of managing voice communications may include receiving, at a communication gateway server (e.g., processor 110), one or more user identifications, including a first user identification, as described above and in the present disclosure. The method may further include associating, by the communication gateway server (e.g., processor 110), a unique identifier with each of the one or more user identification, including associating a first unique identifier with the first user identification, as described above and in the present disclosure.

The method may further include receiving, by the communication gateway server (e.g., processor 110), one or more incoming voice calls, including a first incoming voice call, as described above and in the present disclosure. The method may further include determining, by the communication gateway server (e.g., processor 110), a caller identification of each received incoming voice call, including a caller identification of the first incoming voice call, as described above and in the present disclosure.

The method may further include receiving, by the communication gateway server (e.g., processor 110), an input identifier for each received incoming voice call, including a first input identifier for the first incoming voice call, as described above and in the present disclosure.

The method may further include establishing, by the communication gateway server (e.g., processor 110), a voice communication channel to connect the first incoming voice call to a first computing device (e.g., computing device 120) associated with the first unique identifier when a determination is made, as described above and in the present disclosure, that: (i) the first input identifier received for the first incoming voice call matches the first unique identifier, and (ii) the caller identification of the first incoming voice call has not previously called the first unique identifier before the first unique identifier was associated with the first user identification.

The first unique identifier may be a randomly generated number, as described above and in the present disclosure. Furthermore, the associating may include configuring the first computing device (e.g., computing device 120) to receive incoming communications on the voice communication channel directed to the first unique identifier, as described above and in the present disclosure. The first incoming voice call may be a telephone call to a telephone number assigned to the communication gateway server, as described above and in the present disclosure. Furthermore, the caller identification of the first incoming voice call may be a telephone number that placed the first incoming voice call to the telephone number assigned to the communication gateway server (e.g., processor 110), as described above and in the present disclosure. The first input identifier for the first incoming voice call may also be received after the communication gateway server (e.g., processor 110) answers the first incoming voice call, as described above and in the present disclosure. Furthermore, the voice communication channel may be a VoIP channel, as described above and in the present disclosure.

### Example 3

In another example embodiment, a method of managing voice communications may include configuring a communication gateway server (e.g., processor 110) to receive an instruction to create a first association for a first user identification, as described above and in the present disclosure. The method may further include configuring the communication gateway server (e.g., processor 110) to associate, as the first association, a first unique identifier with the first user identification, as described above and in the present disclosure.

The method may further include configuring the communication gateway server (e.g., processor 110) to receive, after the first association, a first incoming voice call to the communication gateway server (e.g., processor 110), as described above and in the present disclosure. The method may further include configuring the communication gateway server (e.g., processor 110) to determine a caller identification of the first incoming voice call, as described above and in the present disclosure. The method may further include configuring the communication gateway server (e.g., processor 110) to receive a first input identifier for the first incoming voice call, as described above and in the present disclosure. The method may further include configuring the communication gateway server (e.g., processor 110) to establish a voice communication channel connecting the first incoming voice call to a computing device (e.g., computing device 120) associated with the first unique identifier, as described above and in the present disclosure.

The method may further include configuring the communication gateway server (e.g., processor 110) to receive an instruction to remove the association for the first user identification, as described above and in the present disclosure. The method may further include configuring the communication gateway server (e.g., processor 110) to un-associate the first unique identifier from the first user identification, as described above and in the present disclosure. For example, the first user assigned to the first computing device (e.g., computing device 120) may no longer be assigned or allowed to use the first computing device (e.g., computing device 120), as described above and in the present disclosure.

The method may further include configuring the communication gateway server (e.g., processor 110) to receive an instruction to create a second association for the first user identification, as described above and in the present disclosure. The method may further include configuring the communication gateway server (e.g., processor 110) to associate, as the second association, a second unique identifier with the first user identification after the un-associating of the first unique identifier from the first user identification, as described above and in the present disclosure. The second unique identifier may be different from the first unique identifier, as described above and in the present disclosure.

The method may further include configuring the communication gateway server (e.g., processor 110) to receive, after the second association, a second incoming voice call to the communication gateway server (e.g., processor 110), as described above and in the present disclosure. The method may further include configuring the communication gateway server (e.g., processor 110) to determine a caller identification of the second incoming voice call, as described above and in the present disclosure. The method may further include configuring the communication gateway server (e.g., processor 110) to receive a second input identifier for the second incoming voice call, as described above and in the present disclosure. Responsive to a determination that the caller identification of the second incoming voice call matches the caller identification of the first incoming voice call and the second input identifier for the second incoming voice call matches the first unique identifier, the method may further include configuring the communication gateway server (e.g., processor 110) to prevent the second incoming voice call from automatically connecting to a computing device (e.g., computing device 120) associated with the first unique identifier, as described above and in the present disclosure. For example, if an outside caller previously called the first user using the first unique identifier and is now attempting (at a later date) to call the first user using the same first unique identifier, but the first user is now assigned a second unique identifier and a different user (e.g., second user with second user identification) is now assigned the first unique identifier, the method may prevent the outside caller from connecting to the different user.

The communication gateway server may be further configured to establish a voice communication channel connecting the second incoming voice call to a computing device (e.g., computing device 120) associated with the second unique identifier, as described above and in the present disclosure. The communication gateway server may be further configured to establish the voice communication channel connecting the second incoming voice call to the computing device (e.g., computing device 120) associated with the second unique identifier when the second input identifier received for the second incoming voice call matches the first unique identifier and the first unique identifier is currently associated with a second user identification, the second user identification different from the first user identification, as described above and in the present disclosure.

The preventing of the second incoming voice call from automatically connecting to the computing device (e.g., computing device 120) associated with the first unique identifier may include requesting approval, from the computing device (e.g., computing device 120) associated with the second unique identifier, before connecting the second incoming voice call to the computing device associated with the second unique identifier, as described above and in the present disclosure. The communication gateway server may be further configured to send a message to a computing device (e.g., computing device 120) associated with the second unique identifier indicating that the second incoming voice call was received, as described above and in the present disclosure.

Alternatively or in addition, the preventing of the second incoming voice call from automatically connecting to the computing device (e.g., computing device 120) associated with the first unique identifier may include requesting approval, from the computing device (e.g., computing device 120) associated with the first unique identifier before connecting the second incoming voice call to the computing device (e.g., computing device 120) associated with the first unique identifier, as described above and in the present disclosure.

The first unique identifier may be a randomly generated number and the second unique identifier may be a randomly generated number, as described above and in the present disclosure. The first association may include configuring the first computing device to receive incoming communications on the voice communication channel directed to the first unique identifier, as described above and in the present disclosure. The second association may include configuring the first computing device to receive incoming communications on a voice communication channel directed to the second unique identifier, as described above and in the present disclosure. The first incoming voice call may be a telephone call to a telephone number assigned to the communication gateway server (e.g., processor 110), as described above and in the present disclosure. The caller identification of the first incoming voice call may be a telephone number that placed the first incoming voice call to the telephone number assigned to the communication gateway server (e.g., processor 110), as described above and in the present disclosure. The first input identifier for the first incoming voice call may be received after the communication gateway server (e.g., processor 110) answers the first incoming voice call, as described above and in the present disclosure. The voice communication channel may be a VoIP channel, as described above and in the present disclosure.

### Example 4

In another example embodiment, a method of managing voice communications may include receiving one or more user identifications, including a first user identification. The method may further include generating a unique identifier for each of the one or more user identifications, including a first unique identifier for the first user identification. The first unique identifier may be generated based on the following: (i) the first unique identifier is not currently associated with any user identification; and (ii) the first unique identifier has not, during a specified time period, been previously associated with any user identification. The method may further include associating the first unique identifier with the first user identification.

The method may further include receiving one or more incoming voice calls, including a first incoming voice call. The method may further include determining a caller identification of each received incoming voice call, including a caller identification of the first incoming voice call. The method may further include receiving an input identifier for each received incoming voice call, including a first input identifier for the first incoming voice call. The method may further include establishing a voice communication channel to connect the first incoming voice call to a first computing device (e.g., computing device 120) associated with the first unique identifier when: (i) the first input identifier received for the first incoming voice call matches the first unique identifier, and (ii) one or more of the following apply: (a) a determination is made that the caller identification of the first incoming voice call has not previously called the first unique identifier before the first unique identifier was associated with the first user identification, and/or (b) a determination is made that the caller identification of the first incoming voice call was involved with establishing a previous voice communication channel via a second unique identifier and the second unique identifier was associated with the first user identification at the time the previous voice communication channel was established. The second unique identifier may be different from the first unique identifier.

The first unique identifier may be a randomly generated number, and the second unique identifier may be a randomly generated number. The associating may include configuring the first computing device (e.g., computing device 120) to receive incoming communications on the voice communication channel directed to the first unique identifier. The first incoming voice call may be a telephone call to a telephone number assigned to the communication gateway server (e.g., processor 110). The caller identification of the first incoming voice call may be a telephone number that placed the first incoming voice call to the telephone number assigned to the communication gateway server (e.g., processor 110). The first input identifier for the first incoming voice call may be received after the communication gateway server (e.g., processor 110) answers the first incoming voice call. The voice communication channel may be a VoIP channel. Furthermore, the specified time period may include some or all time periods.

Verification Server (e.g., Processor 110).

As illustrated in at least FIGS. 1 and 2, the system (e.g., system 100) may include one or more verification servers (e.g., processor 110). The verification server (e.g., processor 110) may be any processor, device, computing device, server, verification server, transaction server, payment server, communication server, gateway server, communication gateway server (as described above and in the present disclosure), controller, microprocessor, microcontroller, microchip, semiconductor device, or the like, configurable or configured to perform, among other things, a processing of information, voice and/or data communications, transaction request verification and approvals, and/or other actions described above and in the present disclosure. The verification server (e.g., processor 110) may also include and/or be a part of a virtual machine, processor, computer, node, instance, host, or machine, including those in a networked computing environment. In example embodiments, the verification server (e.g., processor 110) and communication gateway server (e.g., processor 110) may be the same or similar server, or duplicate servers, configurable to perform the operations of the verification server (e.g., processor 110) and communication gateway server (e.g., processor 110) described above and in the present disclosure.

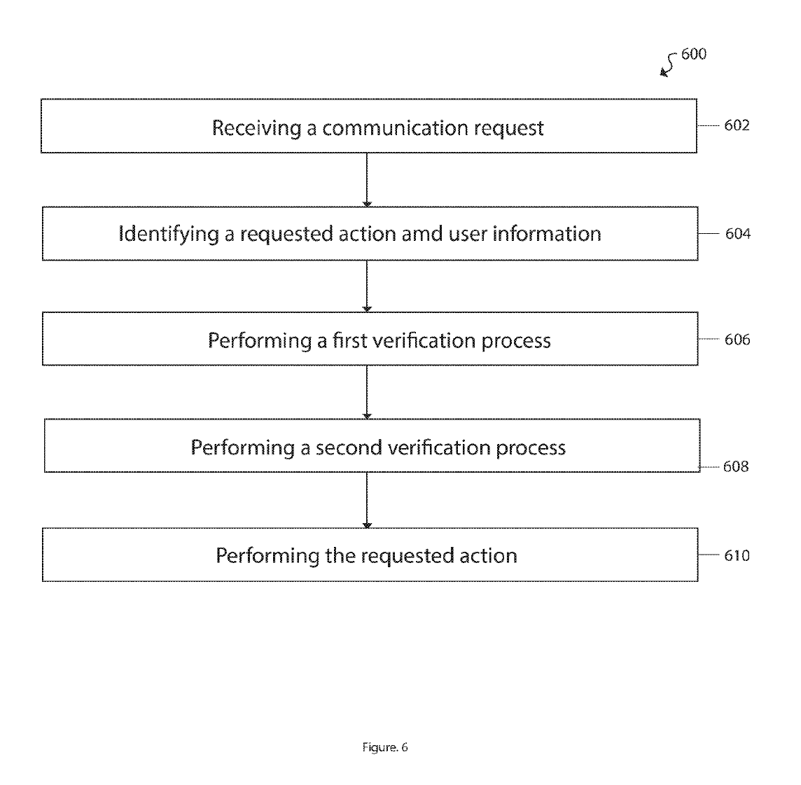

As illustrated in at least FIG. 6, an example embodiment of the verification server (e.g., processor 110) may be configurable or configured to perform verification, authentication, and/or validation of communications with one or more elements of the system (e.g., system 100) (e.g., method 600), such as one or more of the computing devices (e.g., computing device 120), one or more trusted third party networks or systems (e.g., network 140) (such as a bank network or system, clearing house, credit card or debit card processing system or network, etc.), telephones (e.g., device 20c), one or more other communication gateway servers (e.g., processor 110), one or more other verification servers (e.g., processor 110), one or more telephone networks (e.g., telephone network 10), and/or one or more networks (e.g., network 140). Such verification, authentication, and/or validation of communications may require the verification server (e.g., processor 110) to be configurable or configured to first perform a setup process with a computing device (e.g., computing device 120). It is to be understood, however, that the setup process may not be required in example embodiments.

The verification server (e.g., processor 110) may be configurable or configured to perform a plurality of other actions. For example, the verification server (e.g., processor 110) may be configurable or configured to receive a communication request from a computing device (e.g., computing device 120) (e.g., action 602). Once received, the verification server (e.g., processor 110) may be configurable or configured to identify a requested action and/or user information from the communication request (e.g., action 604). The verification server (e.g., processor 110) may then be configurable or configured to perform a first verification process (e.g., action 606). The verification server (e.g., processor 110) may also be configurable or configured to perform a second verification process (e.g., action 608). The verification server (e.g., processor 110) may then be configurable or configured to perform the requested action based on the first verification process and/or second verification process (e.g., action 610). These actions are further described below and in the present disclosure.

Setup Process.

An example embodiment of the verification server (e.g., processor 110) may be configurable or configured to perform a setup process on a computing device (e.g., computing device 120a, 120b, 120c, and/or 120d). The setup process may be performed so as to enable or configure the computing device to perform a transaction, including online bookings, reservations, and/or other transactions (e.g., purchasing a product and/or service, remitting other forms of payment, using online coupons, placing a deposit, etc.), either directly or indirectly through the verification server (e.g., processor 110) directly with or via the verification server (e.g., processor 110).

In an example embodiment, the setup process may include establishing a communication channel between the verification server (e.g., processor 110) and the computing device (e.g., computing device 120). The setup process may further include requesting the user of the computing device (e.g., computing device 120) to provide certain information, such as user information, legal name, billing address, shipping address, credit or debit card information, bank information, identification credentials (e.g., drivers license, passport, national ID card, etc.), an image capture of a payment card (e.g., credit card, debit card, cheque, etc.), an image capture of identification credential(s) (e.g., drivers license, passport, national ID card, etc.), biometric information (e.g., finger print, retina scan, etc.), location information (e.g., via a GPS of the computing device), coupons, email address, phone number, etc. The setup process may further include receiving, by the verification server (e.g., processor 110), the requested information and storing the received requested information in a database. The setup process may further include any other action(s) that may be used in performing a verification of future communication requests (and/or verification during setup) without departing from the teachings of the present disclosure, such as establishing a password, secret information, image capture of a face of the user of the computing device (e.g., computing device 120), voice capture of speech of the user of the computing device (e.g., computing device 120), etc. The setup process may further include verifying the information received from the computing device (e.g., computing device 120), such as via a trusted third party (e.g., a bank network or system, clearing house, credit card or debit card processing system or network, email database system, phone database system, etc.), and/or ensuring the received information is or can be verified by the verification server (e.g., processor 110). The setup process may further include associating the received information to the computing device (e.g., computing device 120). In an example embodiment, the associating of the received information to the computing device (e.g., computing device 120) may be performable prior to, after, or without verifying the received information. In an example embodiment, when an email address and/or phone number is provided, requested, or required, the setup process may include verifying that such email address and/or phone number are reliable email addresses and/or phone numbers (e.g., not disposable email addresses, temporary or newly activated email addresses, suspicious email addresses, pre-paid telephone numbers, etc.).

Receiving a Communication Request (e.g., Action 602).

In an example embodiment, the verification server (e.g., processor 110) may be configurable or configured to receive and/or monitor a communication request originating from the computing device (e.g., computing device 120) (e.g., action 602). The communication request may be a transaction request, such as an online booking request, reservation request, and/or other transaction requests (e.g., purchasing a product and/or service, remitting other forms of payment, using online coupons, placing a deposit, etc.). For example, the verification server (e.g., processor 110) may be configurable or configured to receive a communication request via a communication channel established between the verification server (e.g., processor 10) and the computing device (e.g., computing device 120). Alternatively or in addition, the verification server (e.g., processor 110) may be configurable or configured to monitor (e.g., via an API, server-side application, mobile application, etc.) one or more communication requests sent from the computing device (e.g., computing device 120) to one or more online services or systems (e.g., websites, applications, etc.).

Identify Information from the Communication Request (e.g., Action 604).

The verification server (e.g., processor 110) may be configurable or configured to identify, from the communication request, a first information set and/or a second information set (e.g., action 604). The first information set may include or pertain to a requested action and the second information set may include or pertain to user information (e.g., information of the user of the computing device (e.g., computing device 120). In an example embodiment, the verification server (e.g., processor 110) may be configurable or configured to transform the first information set and second information set to computer-readable information (e.g., via converting, translating, decrypting, normalizing, etc.) so as to obtain the requested action and the user information, respectively.

First Verification Process (e.g., Action 606).

In an example embodiment, the verification server (e.g., processor 110) may be configurable or configured to perform or facilitate the performing of a first verification process (e.g., action 606). The first verification process may include verifying, authenticating, and/or validating the user information received, obtained, and/or transformed from the communication request. For example, the user information received, obtained, and/or transformed from the communication request may include, but are not limited to, information pertaining to the user of the computing device (e.g., computing device 120) such as legal name, billing address, shipping address, credit or debit card information, bank information, identification credentials information (e.g., drivers license, passport, national ID card, etc.), email address, telephone number, etc. Such user information may correspond to and/or match the information provided by the user of the computing device (e.g., computing device 120) during the setup process, as described above and in the present disclosure.

The verification server (e.g., processor 110) may perform the first verification process by verifying, authenticating, and/or validating the received user information against the information provided by the user of the computing device (e.g., computing device 120) during the setup process (and such information provided during setup may or may not already be verified). Alternatively or in addition, the verification server (e.g., processor 110) may perform the first verification process by verifying, authenticating, and/or validating the received user information using a trusted third party system. For example, when the received user information pertains to payment information such as a credit or debit card information, the trusted third party system may be a bank system, credit card or debit card system, clearing house system, etc. As another example, when the received user information pertains to a coupon, gift voucher, or the like, the trusted third party system may be the institution that issued the coupon, gift voucher, or the like. As another example, when the received user information pertains to a name, shipping address, and/or billing address, the trusted third party system may be the bank system, credit card or debit card system, clearing house system, hotel system (e.g., when a hotel issues the computing device to its hotel guest for use during the hotel guest's stay), and/or any other third party system operable to verify, authenticate, and/or validate such information, etc. As another example, when the received user information includes an email address, the trusted third party system may be the company or service that provided, assigned, or is hosting the email address. In such an example, the trusted third party system may also be a service or source that is able to verify (or keeps an updated list of) email addresses so as to determine whether the email address is a reliable and/or disposable email address. As another example, when the received user information includes a telephone number, the trusted third party system may be the company or service that provided, assigned, or is hosting the telephone number. In such an example, the trusted third party system may also be a service or source that is able to verify (or keeps an updated list of) phone numbers so as to determine whether the phone number is a reliable and/or pre-paid phone number. It is to be understood that the first verification process may be performed entirely and/or directly by the verification server (e.g., processor 110) and/or via one or more trusted third party systems, directly or indirectly, partially or wholly, without departing from the teachings of the present disclosure.

Second Verification Process (e.g., Action 608).

The verification server (e.g., processor 110) may be configurable or configured to perform a second verification process (e.g., action 608). In an example embodiment, the second verification process may be performable or performed in response to a determination by the first verification process that the user information is verifiable, authentic, and/or validated. It is to be understood that the second verification process (e.g., action 608) may include one or more of the verifications described above and in the present disclosure for the first verification process in addition to or in replacement of the verifications described below and in the present disclosure for the second verification process.

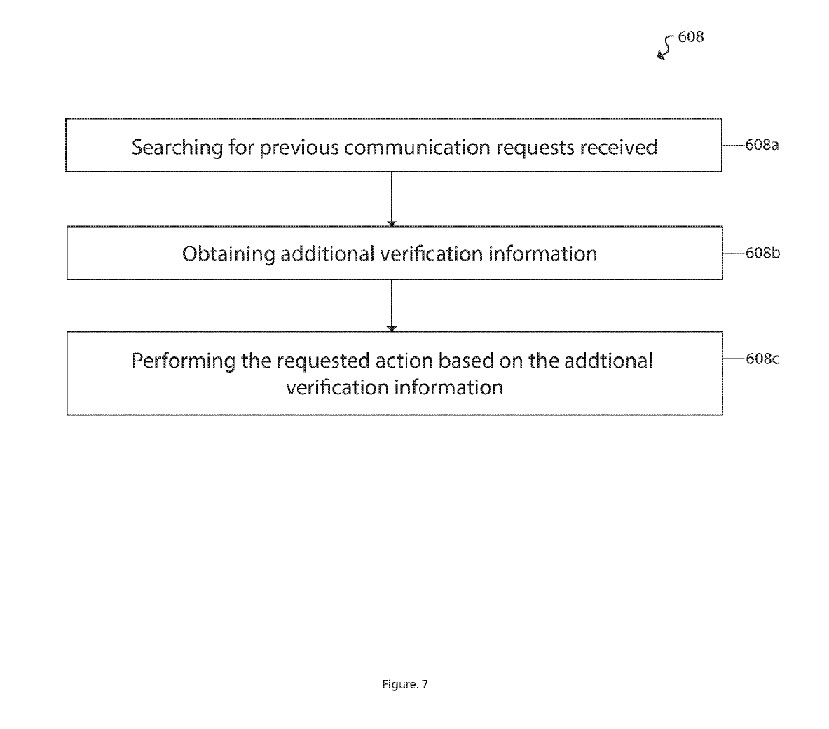

As illustrated in FIG. 7, the second verification process (e.g., action 608) may include searching for previous communication requests (e.g., action 608a). The searching for previous communication requests may be a search for those previous communication requests received and/or monitored by the verification server (e.g., processor 110) having or pertaining to the requested action and/or the verifiable, authentic, and/or validated user information. Such searching may include searching for a predetermined number of previous unit purchases, predetermined number of previous transactions, and/or predetermined number of previous requests received and/or monitored by the verification server (e.g., processor 110) within a predetermined time period. As an example, for a communication request for the purchase of a particular sporting event ticket (corresponding to the requested action in the communication request) by a particular user of the computing device (corresponding to the verifiable, authenticable, and/or validatable user information in the communication request), the verification server (e.g., processor 110) may be configured to perform a search to determine whether the particular user of the computing device has purchased and/or requested more than 4 tickets (as the predetermined number of previous transaction) of the particular sporting event ticket within the past 24 hours (as the predetermined time period). Other criterion, quantities, and/or duration of time are also contemplated without departing from the teachings of the present disclosure.

The second verification process (e.g., action 608) may also include sending, by the verification server (e.g., processor 110) to the computing device (e.g., computing device 120), a notification and/or request to provide further or additional verification, authentication, and/or validation information (e.g., action 608b). For example, the notification and/or request may be provided to the computing device (e.g., computing device 120) when the searching (e.g., action 608a) determines that at least a predetermined number of the same requested actions in previous communication requests received and/or monitored by the verification server (e.g., processor 110) within a predetermined time period resulted in the verification server (e.g., processor 110) performing, based on the verifiable, authenticable, and/or validatable user information, the requested action. As an example situation, if the requested action in a communication request by a particular user (corresponding to the verified, authenticated, and/or validated user information in the communication request) is a purchase of a theme park ticket, the predetermined number of tickets purchased is 10 tickets, and the predetermined time period is the past 2 days, a notification may be sent to the computing device when the verification server (e.g., processor 110) finds that the particular user has previously purchased 10 or more tickets within the past 2 days or less.

In an example embodiment, the notification and/or request to provide further or additional verification, authentication, and/or validation information (e.g., action 608b) may include a notification for the computing device to provide, via an image capturing portion (e.g., camera) of the computing device, a first verification image to verify the verifiable user information. For example, the notification and/or request may be for the user of the computing device to take a photo or video of the credit card or debit card that the user has provided as the form of payment (e.g., as part of the verifiable, authenticable, and/or validatable user information in the communication request). Alternatively or in addition, the notification and/or request may be for the user of the computing device to take a photo or video of a passport, drivers license, national ID card, or the like, that the user has provided as identification (e.g., as part of the verifiable, authenticable, and/or validatable user information in the communication request). Alternatively or in addition, the notification and/or request may be for the user of the computing device to provide a biometric scan (e.g., a fingerprint scan, retina scan, etc.).

In example embodiments, upon receiving the further or additional verification, authentication, and/or validation information, the verification server (e.g., processor 110) may be configurable or configured to perform an extraction of information from the further or additional information. For example, when the further or additional information includes a photo of a credit card (front and/or back), an image recognition process (e.g., optical character recognition or OCR) may be performed on the received photo to extract, among other things, the credit card number, card holder name, expiry date, issuance date, bank name, etc. When the further or additional information includes a photo of a passport, an image recognition process may be performed on the received photo to extract, among other things, the passport holder name, date of birth, citizenship, place of birth, issuance date and expiry date, passport number, etc. The verification server (e.g., processor 110) may also perform other verifications to the received photos, including checking metadata and/or other information associated with the photo, ensuring authenticity of the photo, checking date/time the photo was taken to ensure the photo was taken in response to the notification or request, checking the location where the photo was taken, etc. The verification server (e.g., processor 110) may then be configurable or configured to compare the extracted information with the user information provided in the communication request. Alternatively or in addition, the verification server (e.g., processor 110) may be configurable or configured to compare such the extracted information with previously stored information for the user (e.g., information obtained and stored from the setup process described above and in the present disclosure). Alternatively or in addition, the verification server (e.g., processor 110) may be configurable or configured to compare, further verify, further authenticate, and/or further validate the extracted information with a trusted third party system.

It is recognized that the second verification process may be operable to prevent fraudulent, erroneous, and/or mistaken transactions from occurring.

The verification server (e.g., processor 110) may then be configurable or configured to perform and/or allow, verify, authorize, and/or validate the performance of the requested action contained in the communication request based on the results of the comparing (as described above and in the present disclosure). For example, the requested action contained in the communication request may be performed or allowed to perform when the extracted information (e.g., information extracted from a photo of a credit card) matches the user information provided in the communication request (e.g., credit card information used as the form of payment). As another example, the requested action contained in the communication request may be performed or allowed to perform when the extracted information (e.g., information extracted from a photo of a passport) matches previously stored information for the user (e.g., passport information obtained and stored during a setup process, as described above and in the present disclosure). As another example, the requested action contained in the communication request may be performed or allowed to perform when the extracted information is further verified, further authenticated, and/or further validated by a trusted third party system.

While various embodiments in accordance with the disclosed principles have been described above, it should be understood that they have been presented by way of example only, and are not limiting. Thus, the breadth and scope of the example embodiments described in the present disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

For example, “communication,” “communicate,” “connection,” “connect,” “call,” “calling,” or other similar terms should generally be construed broadly to mean a wired, wireless, and/or other form of, as applicable, connection between elements, devices, computing devices, telephones, processors, controllers, servers, networks, telephone networks, the cloud, and/or the like, which enable voice and/or data to be sent, transmitted, broadcasted, received, intercepted, acquired, and/or transferred (each as applicable).

Also, as referred to herein, a processor, device, computing device, telephone, phone, server, gateway server, communication gateway server, and/or controller, may be any processor, computing device, and/or communication device, and may include a virtual machine, computer, node, instance, host, or machine in a networked computing environment. Also as referred to herein, a network or cloud may be or include a collection of machines connected by communication channels that facilitate communications between machines and allow for machines to share resources. Network may also refer to a communication medium between processes on the same machine. Also as referred to herein, a network element, node, or server may be a machine deployed to execute a program operating as a socket listener and may include software instances.

Database (or memory or storage) may comprise any collection and/or arrangement of volatile and/or non-volatile components suitable for storing data. For example, memory may comprise random access memory (RAM) devices, read-only memory (ROM) devices, magnetic storage devices, optical storage devices, solid state devices, and/or any other suitable data storage devices. In particular embodiments, database may represent, in part, computer-readable storage media on which computer instructions and/or logic are encoded. Database may represent any number of memory components within, local to, and/or accessible by a processor and/or computing device.

Various terms used herein have special meanings within the present technical field. Whether a particular term should be construed as such a “term of art” depends on the context in which that term is used. Such terms are to be construed in light of the context in which they are used in the present disclosure and as one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings and topic headings herein are provided for consistency with the suggestions under various patent regulations and practice, or otherwise to provide organizational cues. These headings shall not limit or characterize the embodiments set out in any claims that may issue from this disclosure. Specifically, a description of a technology in the “Background” is not to be construed as an admission that technology is prior art to any embodiments in this disclosure. Furthermore, any reference in this disclosure to “invention” in the singular should not be used to argue that there is only a single point of novelty in this disclosure. Multiple inventions may be set forth according to the limitations of the claims issuing from this disclosure, and such claims accordingly define the invention(s), and their equivalents, that are protected thereby. In all instances, the scope of such claims shall be considered on their own merits in light of this disclosure, but should not be constrained by the headings herein.

What is claimed is:

1. A system for managing voice communications of one or more computing devices, the system comprising:
a communication gateway server, the communication gateway server configured to:
receive one or more user identifications, including a first user identification;
generate a unique identifier for each of the one or more user identifications, including a first unique identifier for the first user identification, the first unique identifier generated based on the following:
the first unique identifier is not currently associated with any user identification; and
the first unique identifier has not, during a specified time period, been previously associated with any user identification;
associate the first unique identifier with the first user identification;
receive one or more incoming voice calls, including a first incoming voice call;
determine a caller identification of each received incoming voice call, including a caller identification of the first incoming voice call;
receive an input identifier for each received incoming voice call, including a first input identifier for the first incoming voice call; and
establish a voice communication channel to connect the first incoming voice call to a first computing device associated with the first unique identifier when the first input identifier received for the first incoming voice call matches the first unique identifier and when:
the communication gateway server determines that the caller identification of the first incoming voice call has not previously called the first unique identifier before the first unique identifier was associated with the first user identification; and/or
the communication gateway server determines that:
the caller identification of the first incoming voice call was involved with establishing a previous voice communication channel via a second unique identifier, and
the second unique identifier was associated with the first user identification at the time the previous voice communication channel was established, the second unique identifier being different from the first unique identifier.

2. The system of claim 1, wherein the first unique identifier is a randomly generated number.

3. The system of claim 1, wherein the associating includes configuring the first computing device to receive incoming communications on the voice communication channel directed to the first unique identifier.

4. The system of claim 1, wherein one or more of the following apply:
the first incoming voice call is a telephone call to a telephone number assigned to the communication gateway server;
the caller identification of the first incoming voice call is a telephone number that placed the first incoming voice call to the telephone number assigned to the communication gateway server;
the first input identifier for the first incoming voice call is received after the communication gateway server answers the first incoming voice call;
the voice communication channel is a VoIP channel; and
the specified time period includes all time periods.

5. A method of managing voice communications of one or more computing devices, the method comprising:
receiving one or more user identifications, including a first user identification;
generating a unique identifier for each of the one or more user identifications, including a first unique identifier for the first user identification, the first unique identifier generated based on the following:
the first unique identifier is not currently associated with any user identification; and
the first unique identifier has not, during a specified time period, been previously associated with any user identification;
associating the first unique identifier with the first user identification;
receiving one or more incoming voice calls, including a first incoming voice call;
determining a caller identification of each received incoming voice call, including a caller identification of the first incoming voice call;
receiving an input identifier for each received incoming voice call, including a first input identifier for the first incoming voice call; and
establishing a voice communication channel to connect the first incoming voice call to a first computing device associated with the first unique identifier when the first input identifier received for the first incoming voice call matches the first unique identifier and when:
a determination is made that the caller identification of the first incoming voice call has not previously called the first unique identifier before the first unique identifier was associated with the first user identification; and/or
a determination is made that:
the caller identification of the first incoming voice call was involved with establishing a previous voice communication channel via a second unique identifier, and
the second unique identifier was associated with the first user identification at the time the previous voice communication channel was established, the second unique identifier different from the first unique identifier.

6. The method of claim 5, wherein:
the first unique identifier is a randomly generated number; and
the second unique identifier is a randomly generated number.

7. The method of claim 5, wherein the associating includes configuring the first computing device to receive incoming communications on the voice communication channel directed to the first unique identifier.

8. The method of claim 5, wherein one or more of the following apply:
the first incoming voice call is a telephone call to a telephone number assigned to the communication gateway server;
the caller identification of the first incoming voice call is a telephone number that placed the first incoming voice call to the telephone number assigned to the communication gateway server;
the first input identifier for the first incoming voice call is received after the communication gateway server answers the first incoming voice call;
the voice communication channel is a VoIP channel; and
the specified time period includes all time periods.

9. A method of managing voice communications of one or more computing devices, the method comprising:
receiving, at a communication gateway server, one or more user identifications, including a first user identification;
associating, by the communication gateway server, a unique identifier with each of the one or more user identification, including associating a first unique identifier with the first user identification;
receiving, by the communication gateway server, one or more incoming voice calls, including a first incoming voice call;
determining, by the communication gateway server, a caller identification of each received incoming voice call, including a caller identification of the first incoming voice call;
receiving, by the communication gateway server, an input identifier for each received incoming voice call, including a first input identifier for the first incoming voice call; and
establishing, by the communication gateway server, a voice communication channel to connect the first incoming voice call to a first computing device associated with the first unique identifier when a determination is made that:
the first input identifier received for the first incoming voice call matches the first unique identifier; and
the caller identification of the first incoming voice call has not previously called the first unique identifier before the first unique identifier was associated with the first user identification.

10. The method of claim 9, wherein the first unique identifier is a randomly generated number.

11. The method of claim 9, wherein the associating includes configuring the first computing device to receive incoming communications on the voice communication channel directed to the first unique identifier.

12. The method of claim 9, wherein one or more of the following apply:
the first incoming voice call is a telephone call to a telephone number assigned to the communication gateway server;
the caller identification of the first incoming voice call is a telephone number that placed the first incoming voice call to the telephone number assigned to the communication gateway server;
the first input identifier for the first incoming voice call is received after the communication gateway server answers the first incoming voice call; and
the voice communication channel is a VoIP channel.
